(19) United States
(12) Patent Application Publication
(10) Pub. No.: US 2009/0072695 A1
(43) Pub. Date: Mar. 19, 2009

(54) IMAGE DISPLAY DEVICE

(75) Inventors: Taro Hiroike, Yamato-shi (JP); Akira Hayama, Sagamihara-shi (JP); Takeshi Noda, Atsugi-shi (JP); Hideaki Mitsutake, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/281,717

(22) PCT Filed: May 25, 2007
(86) PCT No.: PCT/JP2007/061142

§ 371 Date: Sep. 4, 2008

(30) Foreign Application Priority Data
May 31, 2006 (JP) 2006-151451
May 31, 2006 (JP) 2006-151452
May 10, 2007 (JP) 2007-125150

(51) Int. Cl. H01J 1/88

(52) U.S. Cl. 313/292

(57) ABSTRACT

This is to provide an image display device using a spacer 103 which can reduce an influence which charge has on an electron orbit greatly without depending on electroconductivity of the spacer 103 itself, and a characteristic of a material by making effectual charge amount zero by controlling positive and negative charge distributions generated on a surface of the spacer 103. This is an image display device using a spacer 103 on a main surface of which concavo-convex structure 106 is formed, the spacer 103 having the concavo-convex structure 106 which can cancel mutually positive charge in a convex portion of the concavo-convex structure 106, and negative charge in a concave portion.

### TECHNICAL FIELD

The present invention relates to an image display device which has a first substrate that has an electron source which includes a plurality of electron-emitting devices, a second substrate which has an acceleration electrode for accelerating electrons and is arranged opposite to the first substrate, and a spacer arranged between the first substrate and the second substrate.

### BACKGROUND ART

Heretofore, as a utilization form of an electron-emitting device, an image display device can be cited. For example, a flat-panel type electron beam display panel in which an electron source substrate in which a large number of cold cathode electron-emitting devices are formed, and an opposing substrate equipped with an anode electrode accelerating electrons emitted from the electron-emitting devices, and a fluorescent member as a light-emitting member are made to face each other in parallel, and which is evacuated into a vacuum is known. In addition, hereafter, the electron source substrate is called a rear plate, and the opposing substrate equipped with the anode electrode and the fluorescent member as a light-emitting member is called a face plate. In addition, in the electron beam display panel which is evacuated, a spacer is arranged as atmospheric pressure-proof structure.

In Japanese Patent Application Laid-Open No. 2000-311632 (corresponding to U.S. Pat. No. 6,809,469), an angular dependent multiplication coefficient of a secondary electron emission characteristic in a spacer is specified, and there is a description of that concavo-convex structure is changed according to an incident angle and a distribution of electrons. There is a description regarding a spacer which has random concavities and convexities as an example.

In Japanese Patent Application Laid-Open No. 2003-223858 (corresponding to U.S. Pat. No. 6,963,159), it is described that striped concavities and convexities are formed in a spacer surface, and a groove depth or a groove pitch is changed for every surface area of a spacer. In addition, it is also expressed to use a heating drawing method at the time of spacer substrate formation.

In Japanese Patent Application Laid-Open No. 2003-223857, it is described about a charged state in a concavo-convex shape formed in a spacer surface that a face whose surface faces an electron source side is charged negatively, and a face whose surface faces an electron beam irradiated-member side, or a face along a normal which connects the electron source, and the electron beam irradiated-member is charged positively.

However, we found a new problem that an arrival position of an electron beam, emitted from an electron-emitting device, on a face plate may change according to a drive signal (according to amplitude of a luminance signal) in a display apparatus using conventional spacer structure. In the display apparatus which has this problem, since a position of a bright spot changes with a change of a drive signal for quality of a display image to be deteriorated in consequence, it is necessary to solve it. The present invention aims at providing a new image display device which can solve this new problem.

### DISCLOSURE OF THE INVENTION

Thus, a first of the present invention is to provide an image display device which has:

a first substrate that has an electron source which includes a plurality of electron-emitting devices;

a second substrate which has an acceleration electrode for accelerating electrons, emitted from the electron source, and is arranged opposite to the first substrate; and

a spacer which is arranged between the first substrate and the second substrate, and specifies a gap of the first substrate and the second substrate, characterized in that the spacer has concavo-convex structure in its main surface, and fulfills the following relational expressions with a length of a concave portion of the concavo-convex structure in a direction to the second substrate from the first substrate be A, a length of a convex portion be B, a secondary electron emission coefficient of the concave portion be δ_{A}, a secondary electron emission coefficient of the convex portion be δ_{B}, a probability of an electron being incident into the concave portion and being trapped by the concave portion be α, a depth of the concavo-convex structure be d, and electric field strength between the first substrate and the second substrate during operation of the image display device be E.

$$\begin{matrix}{δ}_{A} ≦ \frac{1}{1 - α} & ( Formula 1 ) \\ \sqrt[α \geq ]{\frac{5 A}{E}} & ( Formula 2 ) \\ 0.5 \times ( \frac{{δ}_{B} - 1}{( α - 1 ) {δ}_{A} + 1} ) ≦ \frac{A}{B} ≦ 1.5 \times ( \frac{{δ}_{B} - 1}{( α - 1 ) {δ}_{A} + 1} ) . & ( Formula 3 )\end{matrix}$$

In addition, a second of the present invention is to provide an image display device which has:

a first substrate that has an electron source which includes a plurality of electron-emitting devices;

a second substrate which has an acceleration electrode for accelerating electrons, emitted from the electron source, and is arranged opposite to the first substrate; and

a spacer which is arranged between the first substrate and the second substrate, and specifies a gap of the first substrate and the second substrate, characterized in that the spacer has concavo-convex structure in its main surface, a length of a concave portion of the concavo-convex structure in a direction to the second substrate from the first substrate be A, a length of a convex portion be B, a concavo-convex ratio A/B becomes large gradually from a side of the first substrate toward a side of the second substrate.

In addition, a third of the present invention is to provide an image display device which has:

a first substrate that has an electron source which includes a plurality of electron-emitting devices;

a second substrate which has an acceleration electrode for accelerating electrons, emitted from the electron source, and is arranged opposite to the first substrate; and

a spacer which is arranged between the first substrate and the second substrate, and specifies a gap of the first substrate and the second substrate, characterized in that the spacer has concavo-convex structure in its main surface, the concavo-convex structure includes a plurality of concavo-convex shapes where maximum angle of inclinations of inclined planes are different, and the maximum angle of inclination of the concavo-convex shape formed in an area in a side of the first substrate is larger than the maximum angle of inclination of the concavo-convex shape formed in an area in a side of the second substrate.

In addition, a fourth of the present invention is to provide an image display device which has:

a first substrate that has an electron source which includes a plurality of electron-emitting devices;

a second substrate which has an acceleration electrode for accelerating electrons, emitted from the electron source, and is arranged opposite to the first substrate; and

a spacer which is arranged between the first substrate and the second substrate, and specifies a gap of the first substrate and the second substrate, characterized in that the spacer has an concavo-convex structure, where a plurality of concavo-convex shapes are formed periodically, in its main surface, and a cycle of the concavo-convex shape in a side of the second substrate is longer than one in a side of the first substrate.

In addition, a fifth of the present invention is to provide an image display device which has:

a first substrate that has an electron source which includes a plurality of electron-emitting devices;

a second substrate which has an acceleration electrode for accelerating electrons, emitted from the electron source, and is arranged opposite to the first substrate; and

a spacer which is arranged between the first substrate and the second substrate, and specifies a gap of the first substrate and the second substrate, characterized in that the spacer has concavo-convex structure in its main surface, the concavo-convex structure includes a plurality of concavo-convex shapes whose depths are different, and the depth of the concavo-convex shape formed in an area in a side of the first substrate is deeper than the depth of the concavo-convex shape formed in an area in a side of the second substrate.

Further features of the present invention will become apparent from the following description of exemplary embodiments with reference to the attached drawings.

### BRIEF DESCRIPTION OF THE DRAWING

FIG. 1 is a sectional view of an electron beam apparatus for describing a first embodiment of the present invention;

FIG. 2 is a sectional view of an electron beam apparatus for describing a second embodiment of the present invention;

FIG. 3 is an illustrative graph about distribution of a concavo-convex ratio of a spacer surface in a first embodiment of the present invention;

FIGS. 4A, 4B, 4C, and 4D are schematic diagrams illustrating examples of concavo-convex shapes which can be adopted as embodiments of the present invention;

FIG. 5 is a partially cutaway perspective view illustrating structure of an electron beam apparatus which is an embodiment of the present invention;

FIGS. 6A and 6B are illustrative diagrams illustrating concavo-convex structure;

FIG. 7 is an illustrative diagram illustrating a charged state of an interior of concavities and convexities;

FIGS. 8A and 8B are illustrative diagrams illustrating aspects of electric fields near a spacer when a charged balance of a spacer surface is broken;

FIG. 9 is a schematic diagram illustrating examples of concavo-convex shapes which can be adopted as embodiments of the present invention;

FIGS. 10A and 10B are illustrative diagrams regarding a parent material shape which curvature unnecessary at the time of a heating drawing does not arise;

FIG. 11 is a schematic diagram illustrating dependency of a secondary electron emission coefficient of a general insulating material on incident energy and an incident angle;

FIG. 12 is an illustrative diagram about a range of suitable distribution of a concavo-convex ratio to a face plate from a rear plate in a spacer base material made from a general material;

FIG. 13 is a schematic diagram of a heating drawing apparatus used for production of a spacer substrate;

FIGS. 14A, 14B, and 14C are drawings illustrating examples of shapes in the case that a plurality of concave portions is formed discontinuously on a surface of a spacer;

FIG. 15 is a sectional view of an image display device for describing a fourth embodiment of the present invention;

FIG. 16 is a sectional view of an image display device for describing a fifth embodiment of the present invention;

FIG. 17 is a sectional view of an image display device for describing a sixth embodiment of the present invention;

FIG. 18 is a sectional view illustrating another example of an image display device for describing the first embodiment of the present invention;

FIG. 19 is an illustrative diagram illustrating a definition of a maximum angle of inclination of concavities and convexities;

FIG. 20 is a schematic diagram illustrating an aspect of an electron orbit which collides against a spacer;

FIG. 21 is a schematic diagram illustrating an example of an array of fluorescent member films formed on a face plate;

FIG. 22 is a graph illustrating a maximum angle of inclination of concavities and convexities in the fifth embodiment of the present invention;

FIG. 23 is a diagram for describing different concavo-convex structures;

FIG. 24 is a diagram for describing area ratios in a case where a plurality of concave portions are discontinuously formed on the surface of the spacer; and

FIG. 25 is a graph illustrating relation between intervals of charges and deterioration of image quality.

### BEST MODES FOR CARRYING OUT THE INVENTION

The present invention relates to an electron beam apparatus, such as image forming apparatus, and in particular, can be suitably used for a flat type image display device using an electron source in which a plurality of electron-emitting devices is arranged on a planar substrate. Before describing a specific form of each invention, features of each invention will be described below simply.

First, according to the first invention, in consideration of incident energy and an incident angle of electrons which are irradiated on a spacer surface, a concavo-convex ratio (ratio of lengths of concave and convex portions) is controlled within a specified range according to a secondary electron emission coefficient for every area on the spacer surface. In consequence, a positive charge amount and a negative charge amount which are generated in one concave-convex cycle become almost the same amount, and hence, an influence which they have on an adjacent electron orbit can be made small. Hence, even if an amount of incident electrons into the spacer surface fluctuates according to a change of a drive signal, a charge amount on the spacer surface becomes approximately zero in one concavo-convex cycle, and hence, an electron beam orbit is stabilized regardless of the change of the drive signal.

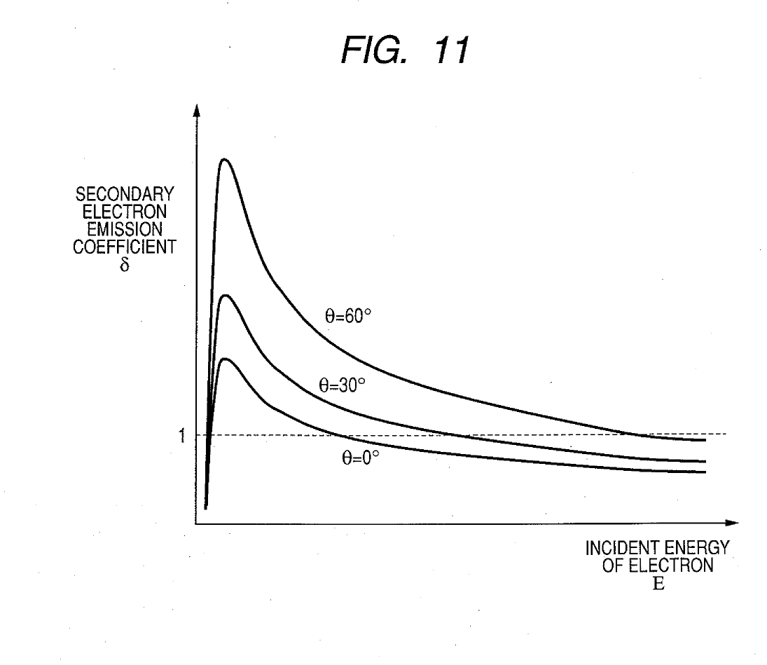

We consider that this is based on the following factors. The secondary electron emission coefficient of the spacer has a distribution according to an operating voltage toward a face plate from a rear plate. In addition, the distribution state expresses a value which changes also according to incident angles of electrons into the spacer, the electrons being incident into the spacer. Its example is shown in FIG. 11. For this reason, structure of providing uniform concavities and convexities in a spacer surface as conventional art, or providing random concavities and convexities causes a distribution of a charge amount on the spacer surface. An influence of the distribution of the charge amount on the spacer surface based on a distribution of such a secondary electron emission coefficient is seldom conspicuous when a change of a drive signal is small. However, as the change of the drive signal becomes large, difference in charge amounts in respective areas of the spacer based on the distribution of the secondary electron emission coefficient appears notably, and in consequence, a change of the electron beam orbit becomes large for a positional offset of a luminescent spot to arise in such an extent of being confirmed visually. In this way, it is necessary to control characteristics of the spacer for every portion (area) because the secondary electron emission coefficient of the spacer indicates a value which is different for every spacer portion (area). In particular, since a portion (area) close to a rear plate of the spacer influences greatly on an orbit of an electron emitted from the electron source, it is necessary to control a charged state precisely. It is necessary to control the secondary electron emission coefficient of the spacer for every area of the spacer for this reason, and in particular, it is necessary to control an area near the rear plate intensively. Then, we arrived at an idea of giving a positive distribution to concavities and convexities in consideration of the distribution of the secondary electron emission coefficient without providing uniform concavities and convexities in a spacer surface as prior art and providing random concavities and convexities.

In addition, according to a second invention, while charge of a spacer surface can be suppressed effectively, an influence to an electron beam orbit from an electron source can be suppressed effectively. Thus, since energy dependence of the incident electron to a spacer is taken into consideration, the present invention can suppress a secondary electron emission coefficient over a whole spacer. Saying in other words, a distribution of the secondary electron emission coefficient of a spacer can be suppressed small. Therefore, even if a change of an amount of incident electrons based on a change of a drive signal arises, a change of a charge amount on a spacer surface can be suppressed. In consequence, it can be suppressed that the electron beam orbit changes with the change of the drive signal. When describing it in full detail, a secondary electron emission coefficient of a spacer made of a general material changes from a first substrate to a second substrate, and becomes larger gradually toward a second substrate side from a first substrate side. Then, depending on amplitude of a voltage applied to an anode of the second substrate, a secondary electron emission coefficient starts to decrease in a short time. Here, although an electron immediately after being emitted from an electron source has small kinetic energy and is easy to be influenced by a slight electric field change, an electron which reaches near the anode has large kinetic energy, and hence, it cannot be easily influenced by an electric field change. Hence, by making a charge amount near the rear plate into zero effectually, electric field distortion near the rear plate which has a large influence on an electron orbit can be reduced, and a suitable operation can be obtained. In addition, by enlarging a ratio of a length A of a concave portion to a length B of a convex portion gradually according to a change of the secondary electron emission coefficient, charge of the whole spacer is suppressed effectively and a change of the electron beam orbit is suppressed.

Furthermore, according to a third invention, by taking an incident angle distribution of incident electrons into a spacer surface into consideration to control a maximum angle of inclination of concavities and convexities, a secondary electron emission coefficient can be suppressed over the whole spacer surface. Saying in other words, a distribution of the secondary electron emission coefficient of a spacer can be suppressed small. Therefore, even if a change of an amount of incident electrons based on a change of a drive signal arises, a change of a charge amount on a spacer surface can be suppressed. In consequence, it can be suppressed that the electron beam orbit changes with the change of the drive signal. When describing it in full detail, since collision angles of electrons which are incident into the spacer surface are large in a first substrate side (incident at a shallow angle) and small in a second substrate side, an average collision angle can be made smaller by forming a concavo-convex slope in accordance with the distribution. Therefore, charge suppression of the spacer surface is made more effective.

Moreover, according to a fourth invention, an influence of charge of a spacer surface can be reduced more effectively. By forming concavities and convexities in a surface of the spacer, charges with both of positive and negative signs are generated for every portion in a concavo-convex shape. When a distance between positive and negative charges is small, influences cancel each other for the influence on an electric field to be able to be suppressed. Since energy of an electron flying near the first substrate side is small (not accelerated), it is more suitable to form concavities and convexities in a shorter cycle in order to heighten an effect of canceling the influence of charge in this area. In addition, not only by decreasing the influence to the electron orbit near the first substrate by arranging concavities and convexities in a short cycle in the first substrate side, but also by making the second substrate side into a long cycle, an electron orbit near the spacer becomes an electron orbit which goes to the spacer closely to the second substrate. This enables control of a behavior of an electron beam as requested.

In addition, according to the fifth invention, while charge of a spacer surface can be suppressed effectively, an influence to an electron beam orbit from an electron source can be suppressed effectively. Thus, since energy dependence of the incident electron to a spacer is taken into consideration, the present invention can suppress a secondary electron emission coefficient over a whole spacer. Saying in other words, a distribution of the secondary electron emission coefficient of a spacer can be suppressed small. Therefore, even if a change of an amount of incident electrons based on a change of a drive signal arises, a change of a charge amount on a spacer surface can be suppressed. In consequence, it can be suppressed that the electron beam orbit changes with the change of the drive signal. When describing it in full detail, by deepening a groove depth of concavo-convex structure, which easily becomes an area where a secondary electron emission coefficient exceeds 1, near an electron source substrate to enhance a locked-in effect of secondary electrons, the secondary electron emission coefficient of this area is brought close to 1. On the other hand, by shallowing a groove depth of concavo-convex structure in the vicinity of an anode, where the secondary electron emission coefficient easily becomes less than 1, the secondary electron emission coefficient of this area is brought close to 1. When describing it in more detail, charges with both of positive and negative signs are generated for every portion in a concavo-convex shape. When positive and negative charge amounts are equal, influences of charges on the electron orbit are canceled. When the first substrate side and second substrate side are compared, the first substrate side has a larger secondary electron emission coefficient at the time of an electronic collision, and it is easy to generate positive charge. When a depth of a concavo-convex shape is deepened, the locked-in effect of electrons is enhanced for negative charge to grow more, and hence, an effect of canceling positive charge increases to be able to suppress the influence on an electron orbit. Therefore, not only the charge is suppressed, but also the influence of the charge is effectively cancelable.

The present invention relates to an electron beam apparatus, such as an image forming apparatus, and in particular, can be suitably used for a flat type image display device using an electron source in which a plurality of electron-emitting devices is arranged on a planar substrate.

Construction of an image display device of the present invention and a spacer used for it will be described below using drawings.

### FIRST EMBODIMENT

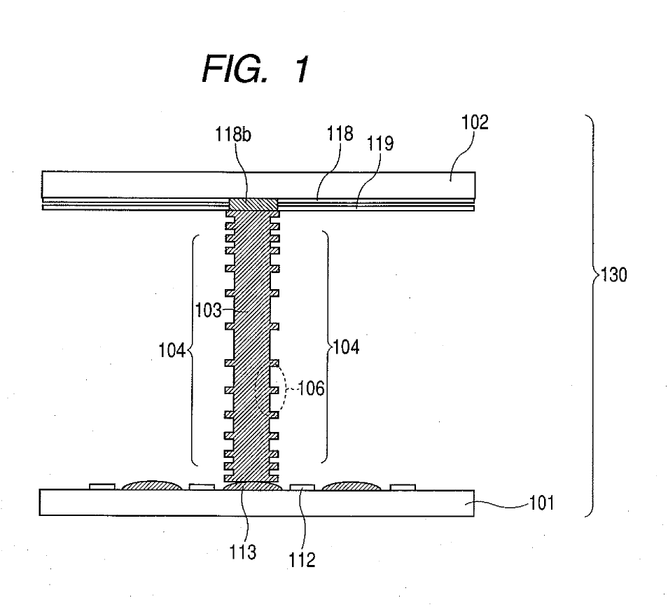

FIG. 1 is a schematic diagram illustrating a section of an embodiment of the image display device produced on the basis of the present invention.

In FIG. 1, a plurality of electron-emitting devices 112 is arranged on a first substrate (hereafter, this is described as a rear plate) 101, and is wired in a matrix with a plurality of row-directional wirings 113 and a plurality of column-directional wirings (not shown).

What is necessary to be the electron-emitting device 112 is just being an electric field emission type or surface conduction type cold cathode electron-emitting device, since the surface conduction type electron-emitting device is especially simple in structure and easy in production, it is suitable in that many devices can be formed over a large area easily.

A fluorescent member layer 118, a metal back 119, and a black member 118b are formed on the second substrate (hereafter, this is described as a face plate) 102. The metal back 119 acts as an acceleration electrode for accelerating electrons emitted from the electron source 111 to the second substrate 102 side by a high voltage being applied from a power supply not shown. The accelerated electrons collide with the fluorescent member layer 118, and a desired image is formed by making the fluorescent member layer 118 emit light.

A space between the rear plate 101 and the face plate 102 forms an airtight container 130 (as a whole, not shown), and its interior is held in vacuum. Therefore, in order to prevent breakage of the airtight container 130 by atmospheric pressure and to keep a gap between the rear plate 101 and the face plate 102 constant, a necessary number of spacers 103 are provided. What are necessary for the spacer 103 are sufficient mechanical strength for supporting the atmospheric pressure applied to the electron beam apparatus and heat resistance to heat applied in production process of the electron beam apparatus. In addition, it needs such insulation that endures a high voltage applied between the rear plate 101 and the face plate 102, and materials, such as glass or ceramics, can be used suitably. In addition, generally, the spacer 103 can take various forms such as a flat plate, and a pillar.

Concavo-convex structure 106 is formed in a main surface 104 of the spacer 103 exposed between the rear plate and the face plate. Here, the concavo-convex structure 106 is made of concave structure, convex structure, or their combination which is formed in a direction approximately parallel to the rear plate and the face plate. This concavo-convex structure 106 does not need to be uniform over the whole spacer, and may be structure which changes depending on a place.

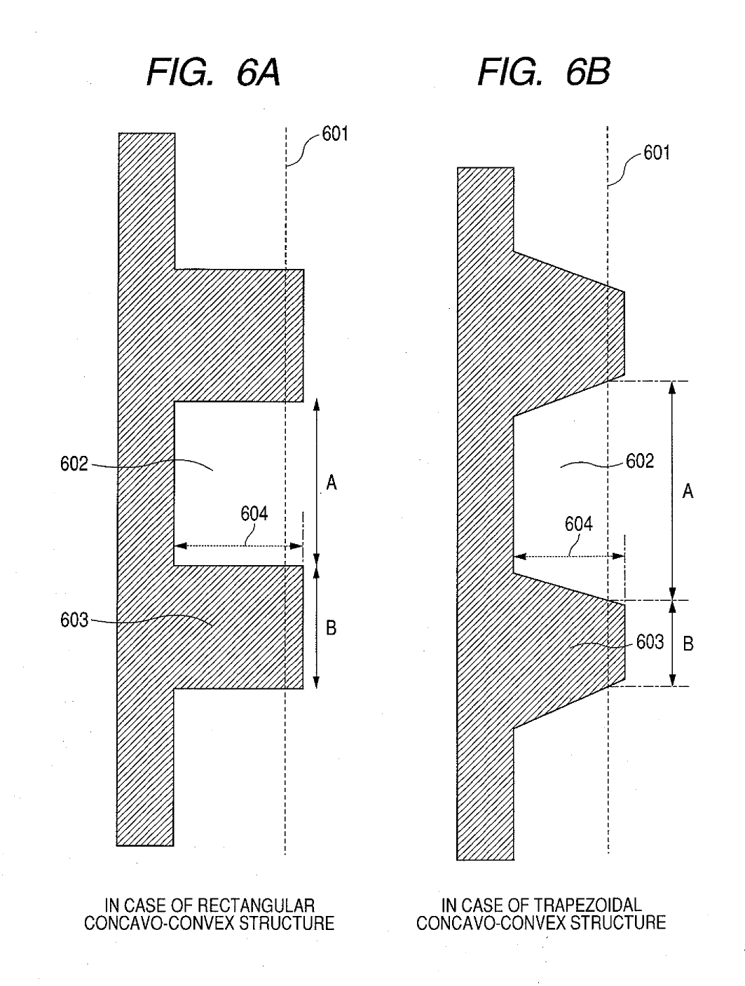

The concavo-convex structure 106 is classified into a concave portion 602 and a convex portion 603 as illustrated in FIGS. 6A and 6B. Here, the concave portion 602 is a portion dented rather than a reference surface (or plane) 601, and conversely, the convex portion 603 is a portion higher than the reference surface 601. The reference surface 601 is a plane expressed in a location which is 90% of the concavo-convex depth. In addition, a depth 604 of the concavo-convex structure 106 is expressed by difference between heights of the convex portion 603 and the concave portion 602.

Here, with letting a length of the concave portion 602 be A and letting a length of the convex portion 603 be B, it is suitable that the concavo-convex structure 106 is formed so that the concavo-convex ratio defined by A/B may fulfill the following relation.

$$\frac{A}{B} = \frac{{δ}_{B} - 1}{( α - 1 ) {δ}_{A} + 1} \qquad ( Formula 4 )$$

Nevertheless, a is a probability that an electron incident into the concave portion 602 is confined in the concave portion 602, and takes a value within a range of 0 to 1. It can be found as follows with an electric field intensity E (V/m) applied between the rear plate and the face plate during a drive of image forming apparatus, and the length A of the concave portion.

$$α = \frac{- 2.5 \times {10}^{- 7} \times E + 5.4}{{A}^{1.8 \times {10}^{- 8} \times E + 0.55}} + 83 \qquad ( Formula 5 )$$

In addition, it is assumed that average initial energy of secondary electrons emitted is 5 eV. Here, it is suitable that a is a value of 0.7 or more in order to form negative charge in the concave portion stably. At this time, it is necessary that a depth d of the concavo-convex structure is equal to or more than the following:

$$\sqrt{\frac{5 A}{E}} . \qquad ( Formula 6 )$$

Incidentally, it should be noted that the above formula 6 is a necessary condition for generating negative charges on the concave portion. In addition, δ_{A} and δ_{B} denote secondary electron emission coefficients in the concave portion 602 and the convex portion 603, respectively.

In addition, δ_{A} is as follows:

$${δ}_{A} ≦ \frac{1}{1 - α} \qquad ( Formula 7 )$$

Since changing by energy of incident electrons and angles at the time of collisions, the secondary electron emission coefficient can take various values from the rear plate to the face plate. Also as for concavo-convex structure 105, it is suitable to take the concavo-convex ratio A/B, which is different in each location, to the face plate from the rear plate according to a change of the secondary electron emission coefficient.

Here, an operation of the spacer with the above-mentioned construction which is a characteristic portion of the present invention will be described.

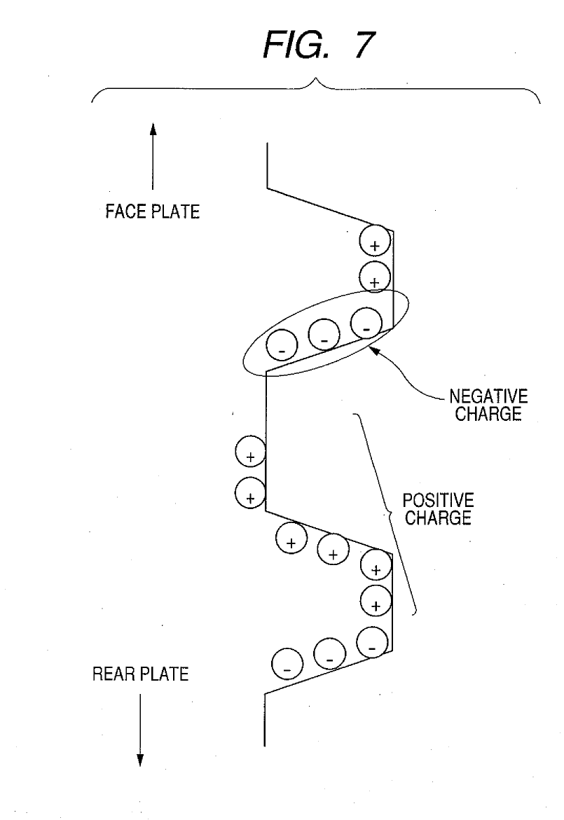

When an image display device is driven, electrons which are given back scattering on a face plate surface collide with a spacer surface. By generating secondary electrons in the spacer surface, the electrons which collide generate charged charges in collision places. When concavities and convexities are formed in a surface, a charged state as illustrated in FIG. 7 according to a concavo-convex shape is formed. That is, faces opposite to the face plate or faces (top surfaces of convex portions) along a normal line connecting the rear plate and the face plate are charged positively, but on the other hand, faces opposite to the rear plate are charged negatively. In other words, by confining electrons in concave portions of the concavo-convex structure, negative charge is formed in the concave portions.

When an amount of positively charged charges and an amount of negatively charged charges which are generated in one concavo-convex structure balance, influences by respective charged charges are canceled mutually and influences which they have on an electric field near the spacer are suppressed, and hence, influences which are given to orbits of electrons which fly near the spacer can be suppressed. In order that the amount of positively charged charges and the amount of negatively charged charges which are generated in one cycle of concavo-convex structure balance, it is necessary that the positive charge amount generated in a convex portion, and the negative charge amount generated in a concave portion are the same amount.

Generally, a positive charge amount q_{convex} generated in a convex portion is calculable as follows:

q_{convex}=N_{B}(δ_{B}−1) (Formula 8)

In addition, a negative charge amount q_{concave} generated in a concave portion is calculable as follows:

q_{concave}=N_{A}(δ_{A}−1)−αN_{A}δ_{A} (Formula 9)

Here, since q_{concave} needs to become a negative value, δ_{A} needs to be as follows:

$${δ}_{A} < \frac{1}{1 - α} . \qquad ( Formula 10 )$$

A symbol α is a probability that an electron incident into a concave portion is confined in a concave portion, and δ_{A} and δ_{B} denote secondary electron emission coefficients by electrons incident into the concave portion and the convex portion, respectively. In addition, N_{A} and N_{B} are the numbers of electrons which are incident into the concave portion and the convex portion.

In order for the positive and negative charge amounts to balance in one concavo-convex structure, a total of q_{convex} and q_{concave} just becomes zero. That is, the following formula just holds:

N_{A}(δ_{A}−1)−αN_{A}δ_{A}+N_{B}(δ_{B}−1)=0 (Formula 11)

When this is transformed, the following relation is obtained:

$$\frac{{N}_{A}}{{N}_{B}} = \frac{{δ}_{B} - 1}{{δ}_{A} ( α - 1 ) + 1} \qquad ( Formula 12 )$$

N_{A}/N_{B} is a ratio of numbers of electrons which are incident into a concave portion and a convex portion, and this is equal to a ratio A/B of lengths of the concave portion and the convex portion. That is, when the following formula is fulfilled,

$$\frac{A}{B} = \frac{{δ}_{B} - 1}{{δ}_{A} ( α - 1 ) + 1} \qquad ( Formula 13 )$$

the same amounts of positive charges and negative charges are generated in the concavo-convex structure, and hence, influences of charges on a nearby electric field are cancelable. In fact, it is not necessary that positive and negative charges balance completely, and what is necessary is just to determine the concavo-convex ratio A/B in a range in which a necessary operation is obtained.

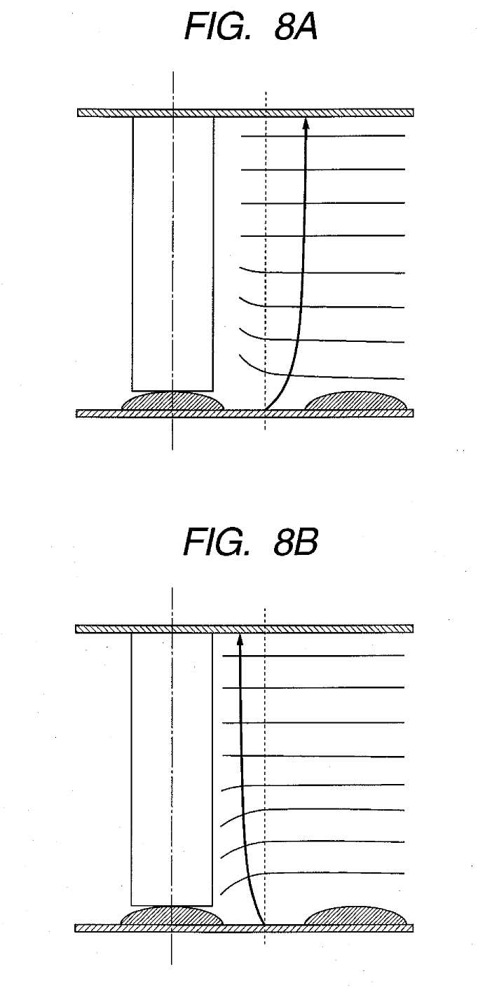

When the A/B deviates from a value of the above formula, that is, when negative charges are more than positive charges in one concavo-convex structure, or conversely, when positive charges are more than negative charges, an electric field near the spacer is distorted, which may have an influence on orbits of electrons which fly in the vicinity. When more negative charges exist, as illustrated in FIG. 8A, such an electric field which keeps an electron orbit at a distance from the spacer is formed near the spacer. On the contrary, when more positive charges exist, as illustrated in FIG. 8B, such an electric field which brings an electron orbit near to the spacer is formed near the spacer. Disorder of a nearby electric field becomes large as balance between negative charges and positive charges becomes off balance, and when disorder of the electric field becomes large to some extent or more, a shift of the nearby beam orbit becomes severe even to such an extent that it can be recognized as disorder of an image.

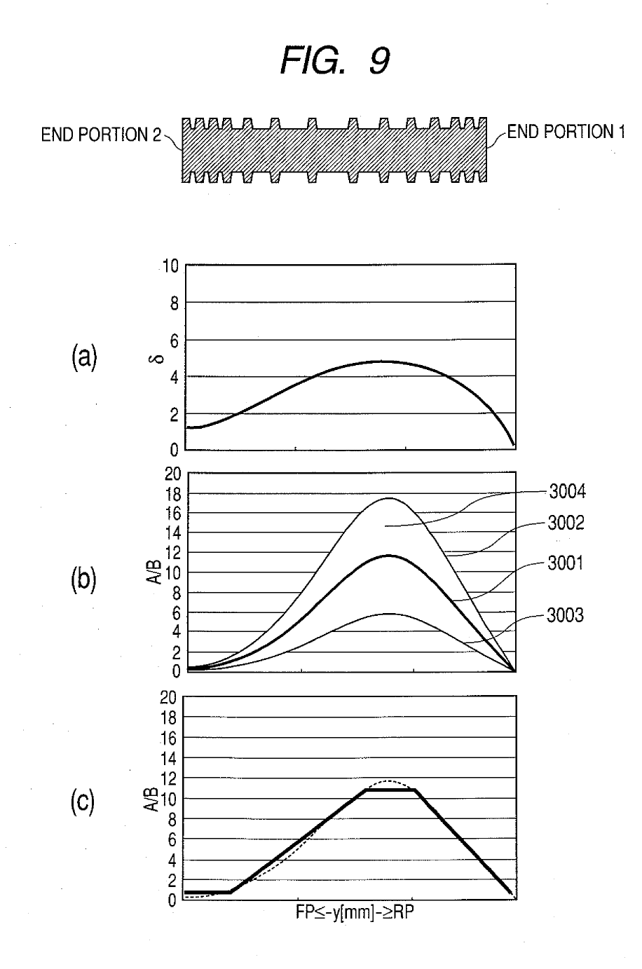

According to investigation of the present inventor et al. by a function evaluation and the like, it turned out that, when an image was seen in a general distance, it was recognized by a person's eyes as disorder of an image when a beam location deviated by 2% or more from a normal location. That is, it was found that a beam deviation amount recognized by the person's eyes as the disorder of the image has a threshold which is equivalent to the beam deviation amount of 2%. The present inventor et al. performed detailed investigation to an amount of a positional offset of an electron orbit near the spacer to difference between the negative charge amount and the positive charge amount. In consequence, as illustrated in the graphs (a), (b) and (c) of FIG. 9, it was found out that a desired effect could be obtained since the positional offsets of electron beams became 2% or less within a range where the difference between the negative charge amount and the positive charge amount did not exceed 50%.

Furthermore, when positive charges become many by 50% or more in comparison with negative charges, electric field strength which goes to the spacer becomes large, and hence, a possibility that one that secondary electrons increase with repeating collisions with a spacer surface, that is, a so-called secondary electron avalanche may arise becomes high. Since the secondary electron avalanche exponentially increases depending on the secondary electron emission coefficient, the charges on the surface of the spacer rapidly progresses. For this reason, since electric field strength near the rear plate increases, a possibility that discharges arise rapidly increases. It is desirable also from this for the difference between the negative charge amount and the positive charge amount not to exceed 50%.

In addition, when a distance to a nearby beam orbit is short, or when a charge amount generated by a secondary electron emission coefficient, a dielectric constant, or the like is large, its influence can be made small by controlling concavities and convexities in a more suitable range as follows:

$$0.8 \times ( \frac{{δ}_{B} - 1}{( α - 1 ) {δ}_{A} + 1} ) ≦ \frac{A}{B} ≦ 1.2 \times ( \frac{{δ}_{B} - 1}{( α - 1 ) {δ}_{A} + 1} ) . \qquad ( Formula 14 )$$

In addition, when applied electric field strength at the time of drive of a general image forming apparatus is made about 3 kV per mm and size (aperture size) of a concave portion is about 5 μm, so long as a depth of the concave portion is 3 μm or more, a sufficiently suitable effect can be obtained. As practical concavo-convex structure of a spacer under such conditions, a depth of the concavo-convex structure is 3 μm or more and 20 μm or less, a length A of a concave portion and a length B of the convex portion is r/10 or less, and the concave-convex ratio A/B is 1 or more and 30 or less. Here, it should be noted that r implies a distance between the main surface of the spacer and the nearest electron-emitting device. In this case, charge on the spacer surface can be suppressed effectively.

Furthermore, a depth d of the concavo-convex structure is equal to or more than the following:

$$\sqrt{\frac{20 A}{E}} \qquad ( Formula 15 )$$

since a probability α that it is confined in the concavities and convexities does not depend on a sectional shape of the concavo-convex structure, or a material of the surface but is stable at the maximum, a more suitable operation can be obtained.

Generally, the secondary electron emission coefficient δ changes according to incident energy and an incident angle. Generally, incident energy dependency of the secondary electron emission coefficient shows a mountain shape characteristic having a peak, as illustrated in FIG. 11. In the case of many materials, peak values of secondary electron emission coefficients δ exceed 1, and they have two incident energies which fulfill δ=1. A secondary electron emission coefficient becomes positive in incident energy between these two crossing point energies, and positive charges are generated in a collision place. Between two crossing point energies, a smaller one is called a first crossing point energy E1, and a larger one is called a second crossing point E2.

A general-purpose scanning electron microscope SEM equipped with an electron current ammeter is used in measurement of the secondary electron emission coefficient. For a primary electron current, a Faraday cup is used. A secondary electron current amount is fixed using what is equipped with a collector (an MCP or the like can be used) as a detector. In addition, this may be found from a sample current and a primary electron current using relation of a continuation law of a sample current, a primary electron current, and a secondary electron current which pass a sample section.

Generally, the measurement is performed under a plurality of incident energy conditions since the secondary electron emission coefficient changes according to incident energy. Furthermore, generally, the measurement is performed with making incident angles 0° and an angle except 0° under the same incident energy condition since the secondary electron emission coefficient changes also according to an incident angle besides incident energy. For incident energy dependability and incident angle dependability which are obtained in this way, fitting by a least-squares method is performed using general formulas (0) and (1) disclosed in Japanese Patent Application Laid-Open No. 2000-311632. Thereby, the dependability of the secondary electron emission coefficient δ on the energy and the angle to various kinds of materials can be determined. In the present invention, the secondary electron emission coefficient is measured when incident angles are 0°, 20°, 40°, 60°, and 80° respectively in a range where incident energy is 500 to 3000 eV, and the above-mentioned fitting is performed. What is necessary for measuring the secondary electron emission coefficients δ_{A} and δ_{B} of the concave portion and the convex portion is just to make a beam spot at the time of measurement equal to or less than the length A of the concave portion and the length B of the convex portion, and to irradiate the concave portion and the convex portion. Alternatively, as mentioned later, the secondary electron emission coefficients of the concave portion and the convex portion may be found by calculation. A degree of vacuum at the time of measurement is 10⁻⁷ Torr (1.3×10⁻⁵ Pa) or less, and measurement is performed at room temperature (20° C.).

A distribution of the secondary electron emission coefficients δ on the spacer surface under drive conditions of the image forming apparatus can be found using the secondary electron emission coefficients obtained in this way. For example, by performing Monte Carlo simulation of orbits of electrons which collide with the spacer, the distribution of the secondary electron emission coefficients on the spacer surface is numerically calculable. At this time, by performing calculation using a model of the spacer surface which has concavo-convex structure, the secondary electron emission coefficients in the concave portion and the convex portion can be obtained. From the distribution of the secondary electron emission coefficients obtained in this way, a distribution of the concavo-convex ratio A/B for making charge into zero effectually can be also found.

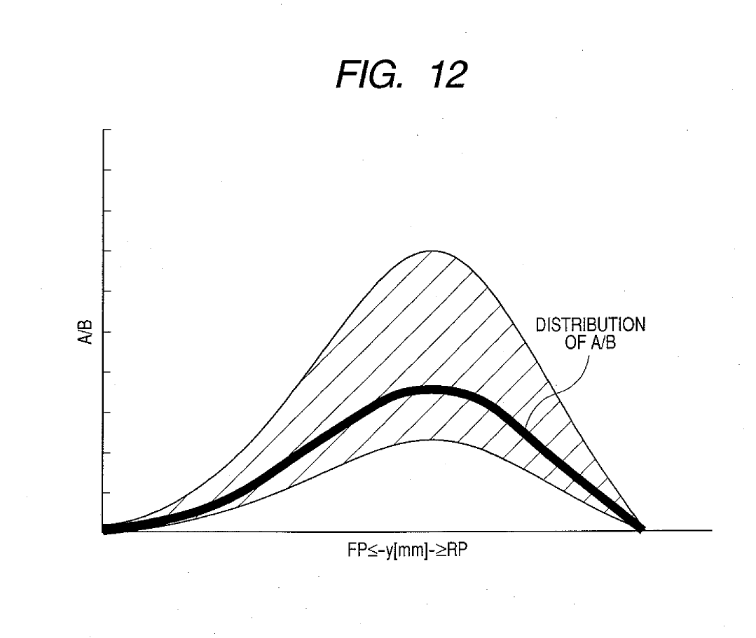

According to numerical simulation of the present inventor et al., generally, the distribution of the concavo-convex ratio A/B for making charge in a spacer surface into zero effectually becomes large toward a face plate side from a rear plate side as shown in FIG. 12. Then, it turned out that it became such a distribution that became small again after reaching a local maximum. This corresponds to that the distribution of the secondary electron emission coefficient becomes a mountain shape distribution which has a peak, as illustrated in FIG. 11. Hence, it is desirable that the concavo-convex ratio A/B in concavo-convex structure of a spacer surface is arranged so that the A/B may become large gradually from the rear plate side to the face plate side, may reach a local maximum, and thereafter, may become small again.

Here, even if a concavo-convex shape of a spacer surface does not always take the above distribution, so long as concavo-convex structure according to the present invention is formed in a part of the spacer surface, an effect of the present invention can be exhibited. That is, as mentioned above, in a place where the ratio A/B of lengths of a concave portion and a convex portion fulfills the relations, the influence of charge is canceled effectually. Generally, in an image forming apparatus using an electron beam, although an electron immediately after being emitted from an electron source has small kinetic energy and is easy to be influenced by a slight electric field change, an electron which reaches near an anode has large kinetic energy, and hence, it is not easily influenced by an electric field change. Hence, by making a charge amount near the rear plate into zero effectually, electric field distortion near the rear plate which has a large influence on an electron orbit can be reduced, and thereby, a suitable operation can be obtained. For the purpose, what is necessary is just that, in a partial area of the rear plate side, the A/B complies with the relations of the present invention, and concavo-convex structure which becomes large gradually toward the face plate side is formed (as for a specific example, refer to FIG. 18 mentioned below).

In addition, as mentioned above, the value of A/B enables to obtain a desired effect in a range where the difference between the negative charge amount and the positive charge amount does not exceed 50%. This means that, when forming a concavo-convex ratio within a diagonally shaded area in FIG. 12, a desired effect is obtained.

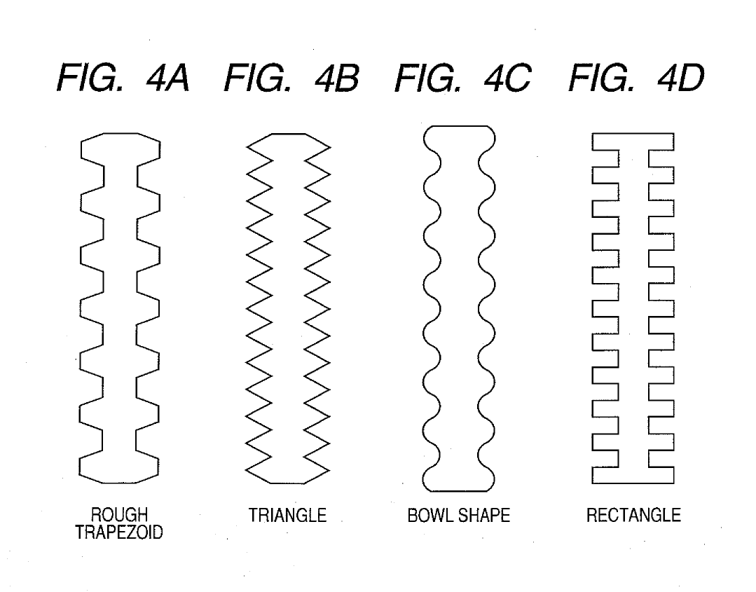

The sectional shape of the concavo-convex structure in the present invention can take various shapes such as a rough trapezoid (4A), a triangle (4B), a bowl shape (4C), and a rectangle (4D), as shown in FIGS. 4A to 4D. Convex-concave having not only one kind but also a plurality of kinds of sectional shapes may be mixedly used. In particular, when it is a material with a large secondary electron emission coefficient, a more suitable operation can be obtained by determining a sectional shape of concavo-convex structure in consideration of an incident angle distribution of electrons.

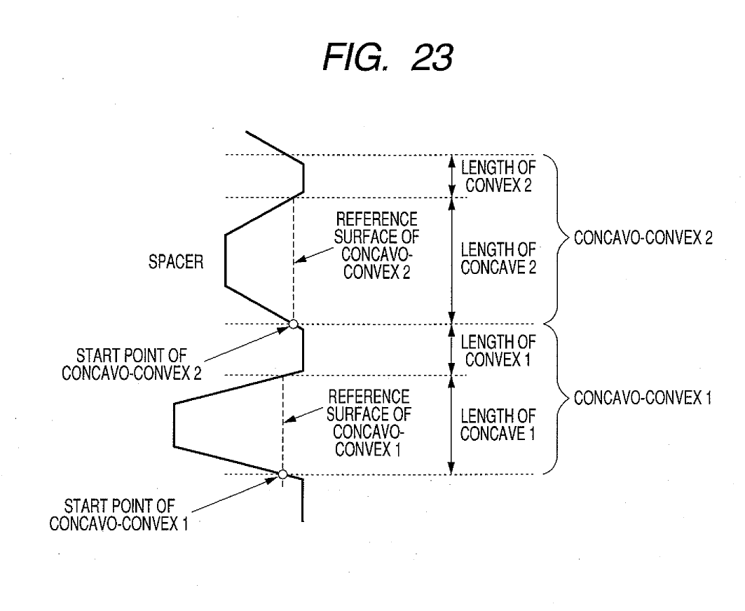

Incidentally, a length A of the concave portion and a length B of the convex portion in a case where the surface of the spacer has various concavo-convex shapes as described above will be described with reference to FIG. 23. That is, if the surface of the spacer has the various concavo-convex shapes, a reference surface is calculated with respect to each concave portion, whereby the length of each concave portion is individually calculated, and, based on the calculated results, the length of each convex portion is individually calculated. FIG. 23 illustrates an example of such processes. That is, as illustrated in FIG. 23, the depth of a concavo-convex 1 is different from the depth of a concavo-convex 2. However, even in such a case, as described above with reference to FIG. 7, a line parallel to the normal line of the first substrate is extended in each concave portion at the location which is 90% from the bottom of the relevant concave portion, and the length A of the concave portion is defined by the distance (length) between the intersection points that the extended line intersects the inner walls of the concave portion. By performing such calculation for each concave portion, the length A is calculated with respect to each concave portion. Further, in each concave portion, the intersection point between the surface of the concave portion facing the second substrate (face plate) and the reference surface is set as the start point of the relevant concave portion. Then, a value which is obtained by subtracting the length A of the concave portion (concave 1) on the near side of the first substrate (rear plate) from the distance (length) between the start points of the adjacent concave portions (concave 1 and concave 2) is set as the length B of the convex portion (convex 1) between the adjacent concave portions. Further, one concavo-convex structure is formed by the concave portion located on the side of the first substrate and the convex portion located close to the relevant concave portion and located on the side of the second substrate rather than the relevant concave portion, and the distance between the adjacent concave portions (the distance between the start points of the adjacent concave portions) is equivalent to one period of the concavo-convex structure.

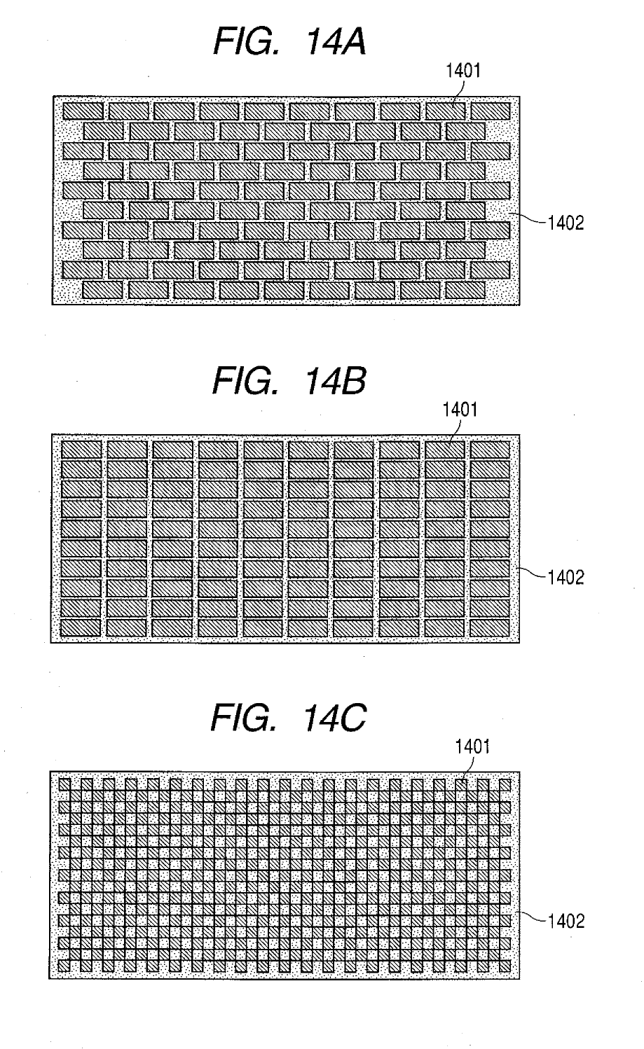

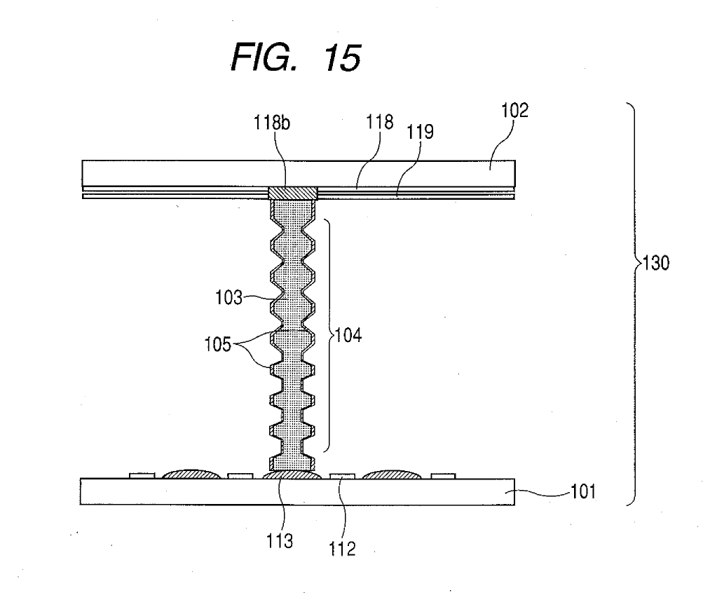

In addition, concavo-convex structure may be in not only, for example, a shape that a concave portion parallel to a longitudinal direction of a tabular spacer is formed continuously, but also, for example, a shape that a plurality of concave portions are formed discontinuously on a spacer surface, as illustrated in FIGS. 14A, 14B, and 14C. FIGS. 14A to 14C are schematic diagrams with viewing a main surface of a tabular spacer from a surface, reference numeral 1401 denotes a concave portion, and reference numeral 1402 denotes a convex portion (portion which is not a concave portion). In FIG. 14, although every concave portion 1401 has a rectangle-like aperture section, a shape of an aperture is not necessarily limited in a rectangle, but, for example, it may be a circle, or an irregular shape. In short, what is necessary is that, in a location in which concavo-convex structure is formed, an area ratio of a concave portion and a convex portion (portion which is not the concave portion) just fulfills the relations.

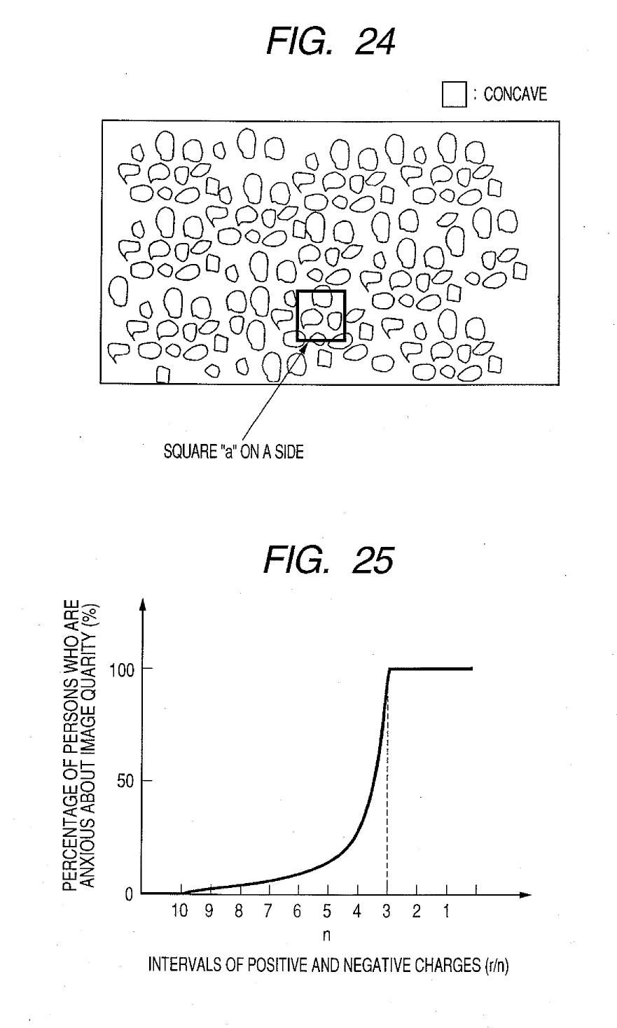

Incidentally, the areas of concave and convex portions discontinuously formed are defined as follows. That is, as illustrated in FIG. 24, a square region that the length of one side “a” is first conceived on the main surface of the spacer. With respect to the depth of the concave portion included in the square region (that is, the maximum depth of the concave portion if only one concave portion is included, and the mean value of the maximum depths of the respective concave portions if the plurality of concave portions are included), the surface which is expressed in a location which is 90% of the depth from the bottom of the concave portion is set as a reference surface (or plane), and the portion which is deeper than the reference surface is defined as the concave portion, and the portion which is shallower than the reference surface is defined as the convex portion. The areas of the concave and convex portions are respectively the areas of the concave and convex portions which are defined as above. If the area of the concave portion and the area of the convex portion are added together, a² is obtained. Here, a size of the square region is determined as follows. That is, to reduce an influence of charges on the spacer surface to an electron orbit located thereby, it is preferable to reduce an interval between positive and negative charges on the spacer surface. The present inventor et al. determined an optimum range of the intervals between the positive and negative charges as follows. First, simulated image data is generated by obtaining an electron beam deviation amount in a case where positive and negative charges are generated with various intervals in a numerical simulation. Next, an image represented by the generated simulated image data is evaluated based on a subjective evaluation method recommended by CCIR Recommendation 500-5. As a result, the relation as illustrated in FIG. 25 is obtained. Here, it should be noted that, if it is assumed that the distance between the spacer surface and the electron-emitting device is r, the horizontal axis of FIG. 25 indicates which number part of r the interval between the positive and negative charges is. For example, if 10 is given, the interval between the positive and negative charges is r/10. Further, it should be noted that the vertical axis of FIG. 25 indicates the subjective evaluation, that is, a percentage of persons who are anxious about image quality (2 or less in five-stage evaluation). As a result of evaluation, it is desirable that the interval between the positive and negative charges is at least r/3 or less, and, more preferably is r/10 or less. Accordingly, with respect to the above size of square region, it is necessary to set the length a of one side to r/3 or less, and, more preferably to r/10 or less.

Furthermore, as mentioned above, in the concavo-convex structure formed in a spacer surface, electric charges with both of positive and negative signs are generated in its interior for influences of both to be cancelled, and hence, the influences which they have on a nearby electric field can be reduced. Nevertheless, in the vicinity of a spacer, that is, in an area approaching the spacer in comparison with a gap of positive and negative charges, there is a range where a change of an electric field to the extent of influencing an electron orbit is generated without the influences of the positive and negative charges being canceled. The range is nearly a gap between the positive and negative charges, and the larger the gap between the positive and negative charges is (the longer a concavo-convex cycle is), the more widely the influences of the charges reach. Hence, with letting a distance between a typical surface of the spacer, and an electron source, which is in a nearest location from the spacer, be r, it is desirable that the gap between the positive and negative charges, that is, a length A+B of the concavo-convex structure is r or less.

Subsequently, a production method of the above-mentioned spacer of the present invention will be described.

As a processing method of a concavo-convex shape to a spacer surface, selection can be freely performed among methods of being able to form the concavities and convexities shape. Various kinds of production methods such as physical methods, such as a mechanical cutting method, and polishing, chemical methods, such as a photolithography, and an etching method, and a method of molding using a material which is shape-transformable by unit such as heating are applicable. Among them, a heating drawing method is especially suitable in point of being excellent in mass productiveness, the heating drawing method which forms a concavo-convex shape in a parent material, such as glass which is a material which is shape-transformable by heat, by machining or molding, and forms a spacer by drawing it under heating at near a softening point or higher.

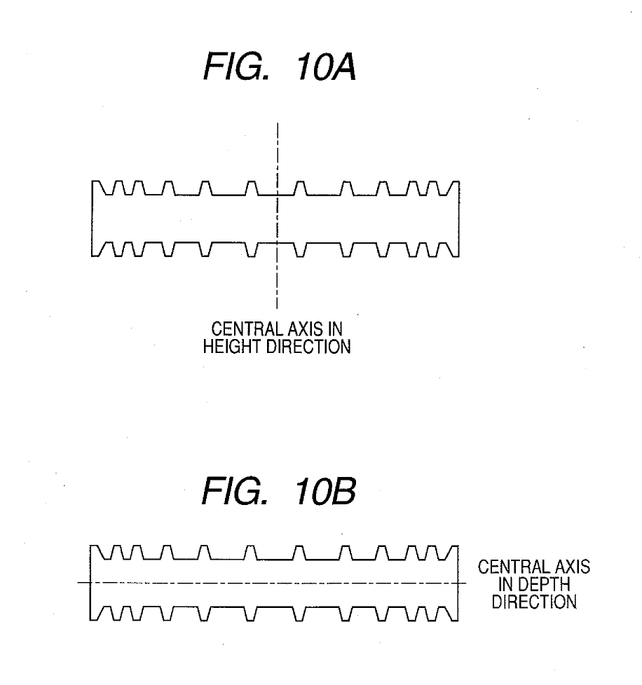

When processing the parent material, which has a concavo-convex shape, by a heating drawing method, depending on the shape of the parent material, an unnecessary warpage and the like may arise in a member after drawing. This is because difference of heat capacity arises for every place since average surface area and volume differ from each other in each portion of the parent material, and difference in a heating rate or a cooling rate arises as a result. In this embodiment, as shown in FIGS. 10A and 10B, in two areas which is divided by a central axis in a longitudinal direction (a height direction in FIG. 10A) or in a lateral direction (a depth direction in FIG. 10B) in a main section of a parent material, their volumes or surface areas, or both are equal mostly. Such parent material shape enables to suppress occurrence of an unnecessary warpage since a temperature distribution along one direction in the main section becomes a mostly symmetrical distribution in the parent material, the spacer, or its intermediate state in a heating drawing process.

Then, a production method of the image forming apparatus which is an electron beam apparatus using the spacer of the present invention will be described simply. In production of the image forming apparatus to which the present invention was applied, the same construction and production method as what was disclosed in Japanese Patent Application Laid-Open No. 2000-311633 were used.

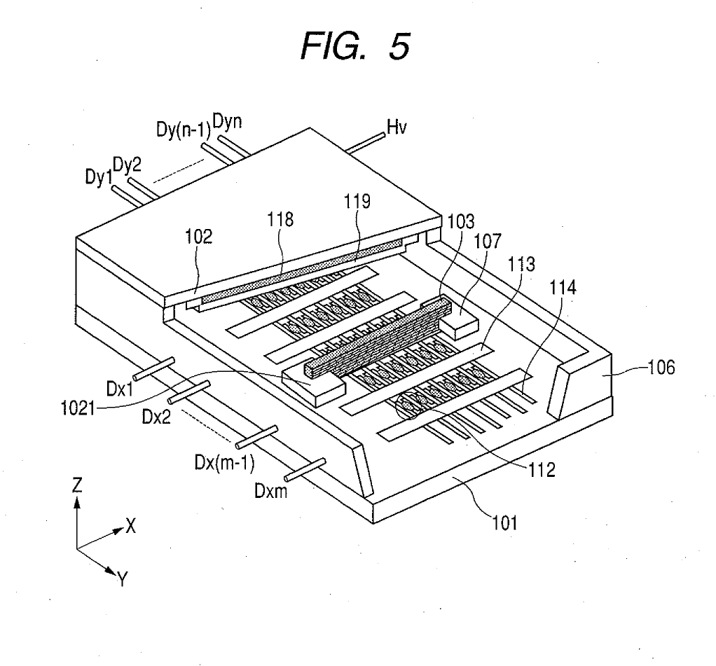

FIG. 5 is a perspective view in one embodiment of the image forming apparatus using the spacer produced on the basis of the present invention, and illustrates it with cutting a part of a panel in order to illustrate internal structure.

In the figure, reference numeral 101 denotes a rear plate, reference numeral 106 denotes a side wall, and reference numeral 102 denotes a face plate, and these form an airtight container for maintaining an interior of a display panel to a vacuum.

Reference numeral 103 denotes a spacer produced on the basis of the present invention, and the necessary number of them are arranged inside the panel for the purpose of not only keeping a gap between the rear plate 101 and the face plate 102 at a predetermined gap, but also preventing damage of the airtight container by atmospheric pressure difference between the interior and exterior of the airtight container which is evacuated. Reference numeral 107 denotes a block used for fixing a spacer to a desired location.

N×M pieces of cold cathode devices 112 are formed on the rear plate 101. (N and M are two or more positive integers, and are suitably set according to a display pixel count to be intended. For example, in a display apparatus aiming at display of high-definition television, it is desirable to set N=3000 and M=1000 or larger numbers). The above-mentioned N×M pieces of cold cathode devices are wired in a simple matrix by M lines of row-directional wiring 113 and N lines of column wiring 114.

So long as an electron source used for the image display device of the present invention is an electron source that cold cathode devices are wired in a simple matrix, there is no restriction in materials, shapes, or a production method of the cold cathode devices. Hence, for example, a cold cathode device, such as a surface conductive emission device or a FE type one, can be used. Among them, since a surface conduction type electron-emitting device is simple in structure and easy to produce, it is suitable at a point that many devices can be formed over a large area easily.

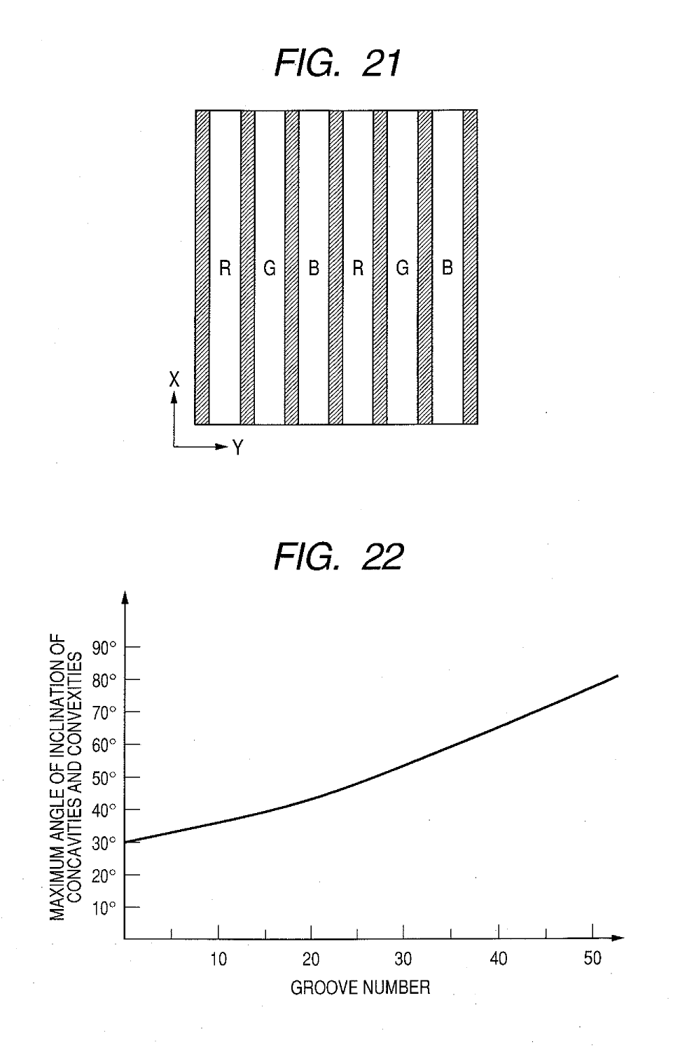

A fluorescent member film 118 is formed on an undersurface of the face plate 102. Since this embodiment is a color display apparatus, fluorescent members in three primary colors of red, blue, and green which are used in a CRT field are separately applied in a portion of the fluorescent member film 118. A fluorescent member in each color is separately applied in stripe geometry, and a black member is provided between stripes of the fluorescent members (see FIG. 21 in which “R”, “G” and “B” are fluorescent bodies).

In addition, a metal back 119 which is publicly known in the CRT field is provided in a face in a rear plate side of the fluorescent member film 118. This metal back 119 is used as an electrode for enhancing use efficiency of light which the fluorescent member 118 emits, protecting the fluorescent member 118 from impacts of ions and the like, and further applying an accelerating voltage for accelerating electrons emitted from the electron-emitting devices.

Furthermore, since details regarding construction and a production method of an electron source, a face plate, and a display panel including them are as disclosed in the above-mentioned Japanese Patent Application Laid-Open No. 2000-311633, their description is omitted.

### SECOND EMBODIMENT

Next, a second embodiment of the present invention will be described.

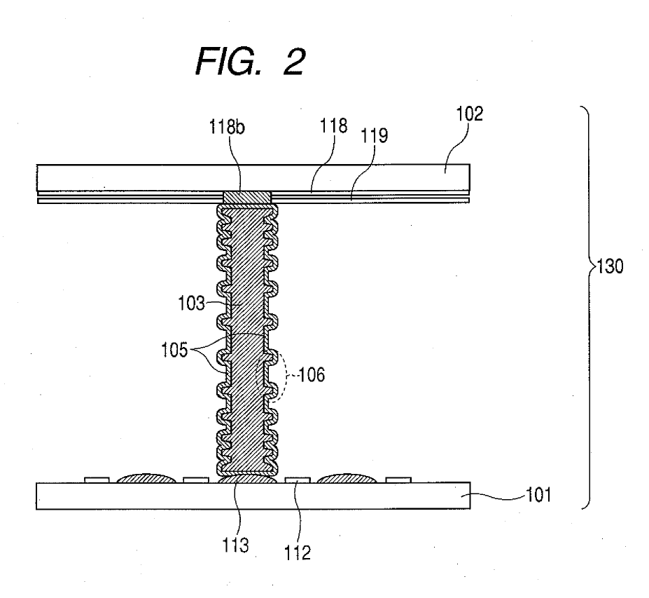

FIG. 2 is a sectional diagram of an image forming apparatus in the second embodiment. Reference numerals in the figure are the same as those in FIG. 1. In this second embodiment, a point that a high resistivity film 105 is formed on a surface of the spacer 103 is different from the first embodiment. Since other portions are the same as those in the first embodiment, description here is omitted, and, regarding the spacer which is a feature of this embodiment, its construction and operation will be described.

The high resistivity film 105 formed on the surface of the spacer 103 is formed in order not only to specify potential of a spacer creepage surface, but also to remove charged charges. The high resistivity film needs to have a sheet resistance value to an extent necessary for achieving the above-mentioned operation. Ordinarily, it is desirable that a sheet resistance value of the high resistivity film 105 is 10¹⁴ Ω/square or less, and in order to obtain a further sufficient effect, it is desirable to be 10¹² Ω/square or less. On the other hand, when resistance is too low, there arises an issue that the power consumption in the spacer increases. Hence, 10⁷ Ω/square or more of sheet resistance is desirable.

As a material for such the high resistivity film 105, for example, a metal oxide can be used. Also in metal oxides, oxides of chromium, nickel, and copper are suitable materials. It is because these oxides have comparatively small secondary electron emission efficiencies, and hence, also when electrons emitted from the electron-emitting device 112 collide with the spacer 103, a charge amount generated is small. Carbon besides the metal oxides is a suitable material with a small secondary electron emission efficiency. In particular, since amorphous carbon has high resistivity, it is easy to control spacer resistive at a desired value.

Furthermore, as for other materials for the high resistivity film 105, nitrides of aluminum and transition metal alloys are suitable materials since resistance values are controllable in a wide range of from a good conductor to an insulating member by controlling a composition of a transition metal. As the transition metal elements, Ti, Cr, Ta, and the like are cited.

In addition, since nitrides of germanium and transition metals also have good charge reduction characteristics by controlling compositions similarly, they can be used suitably as materials for the high resistivity film 105. As transition metal elements, Ti, V, Cr, Mn, Fe, Co, Ni, Cu, Zr, Nb, Mo, Hf, Ta, W and the like are cited. These transition metals are independent and it is possible to use in accordance with two or more kinds of transition metals alternatively.

These high resistivity films can be formed on the surface of the spacer 103 by thin film forming unit, such as a sputter, electron beam metallization deposition, ion plating, an ion assisted deposition method, a CVD method, and plasma CVD.

Moreover, the spacer 103 abuts on the row-directional wiring 113 on the rear plate 101, and the metal back 119 which is an acceleration electrode on the face plate 102. In the above-mentioned abutting portions, the high resistivity film 105 is electrically connected to the row-directional wiring 113 and the metal back 119. In addition although the spacer 103 abuts on the row-directional wiring 113 in this example, an electrode for abutment is provided on the rear plate separately, and it may be made to abut on there.

In addition, low resistive films for taking electric connection securely may be formed on the abutting surfaces with the rear plate and the face plate. As the low resistive film, materials having sufficient low resistance values in comparison with the high resistivity film. Metals, such as Ni, Cr, Au, Mo, W, Pt, Ti, Al, Cu, and Pd, or alloys, and printed electroconductive members which include metals and metal oxides, such as Pd, Ag, Au, RuO₂, and Ag.PdO, glass and the like can be used. Alternatively, it is selected suitably from conductive particulate dispersion films in which conductive particulates made by doping particulates, which are constructed of semiconductor materials such as SnO₂, with dopants such as Sb are dispersed in an inorganic or organic binder, transparent electroconductive members such as In₂O₃—SnO₂, and semiconductor materials, such as polysilicon.

In addition, FIG. 18 illustrates a case that the A/B becomes large gradually toward the face plate as a shape of the spacer.

### THIRD EMBODIMENT

Next, a third embodiment of the present invention will be described.

In the third embodiment, the spacer 103 is different from that in the first embodiment in that it is made of a base material which has slight electroconductivity. Since other portions are the same as those in the first embodiment, description here is omitted, and, regarding the spacer which is a feature of this embodiment, its construction and operation will be described.

Addition of conductivity to the spacer base material is performed in order to remove generated charged charges effectively, while specifying potential of a spacer surface. Since the addition of conductivity to the base material makes a vacuum process for film formation, and the like unnecessary, for example, in comparison with a case of forming a high resistivity film on a surface to obtain the same effect, manufacturing cost of the spacer and the image forming apparatus can be reduced.

Nevertheless, when resistance of the spacer base material becomes low, characteristics of the spacer may be spoiled by heat generation by a current flowing, and the like in addition to increase of power consumption of a spacer section.

In order to obtain the above-mentioned suitable operation, in view of such a point, as a base material of the spacer, it is desirable for volume resistivity to be 10⁵ Ωcm or higher. More suitably, it is desirable for volume resistivity to be 10⁸ Ωcm or higher.

As a conductive base material, materials that conductive particles, such as a metal oxide, are mixed into an insulating base material, such as glass, can be suitably used.

Next, a production method of the conductive base material mentioned above will be described.

First, an insulating base material and powder of conductive particles are prepared, respectively. Although powder production unit is not limited particularly, a physical method such as a grinder, a laser type, or induction heating type particulate production machine, or a chemical method such as an aerosol spraying method, or a thermal decomposition method can be used suitably. The obtained fine grinding powder is sieved and classified by a dry classifier or a wet classifier so as to become desired grain size.

Next, the above-mentioned insulating base material and the conductive particle powder which are calibrated in accordance with various composition concentration ratios are mixed. For example, powder of golden particles is mixed with glass. Although mixing unit is not limited particularly, what is necessary is just for a ball mill or the like to perform it. In order to prevent deterioration of conductive particles, it is suitable to perform mixture in non-oxidizing atmosphere, such as a nitrogen gas or an Ar gas. After mixture, according to necessary grain size, they are classified with a sieve, a dry type classifier, a wet classifier, or the like.

Subsequently, pre-baking of this mixed powder is performed in a nitrogen gas or an inert gas ambient atmosphere, such as an Ar gas, or a vacuum. In addition, it is sufficient to perform pre-baking in a reducing atmosphere, such as hydrogen. Suitably, a solid matter is obtained by heating it at 800 to 1500° C. and performing the pre-baking.

Next, the solid matter made in this way is ground. Although grinding unit is not limited particularly, what is necessary is just for a ball mill or the like to perform it. Grinding is performed in a non-oxidizing atmosphere, such as a nitrogen gas or an Ar gas. After grinding, according to necessary grain size, they are classified with a sieve, a dry type classifier, a wet classifier, or the like.

Finally, a sintered compact is obtained by performing pressurized baking of this mixed powder, obtained by the grinding, in a nitrogen gas or an inert gas ambient atmosphere, such as an Ar gas, or a vacuum. It is no matter to perform pressurized baking in a reducing atmosphere, such as hydrogen. It is suitable to use a hot press method for pressurized baking. It is formed so that it may become a predetermined plate thickness and a shape, and it is made a conductive member through a step of main baking that heating at 800 to 1500° C. is performed under pressure of 1 to 2 MPa suitably.

In this way, the obtained conductive member is suitably cut in a predetermined shape, and they are made spacers of the image display device in the present invention which have concavities and convexities on surfaces.

For the obtained spacers, similarly to the second embodiment, low resistive films for taking electric connection securely may be formed on the abutting surfaces with the rear plate and the face plate. As the low resistive films, materials having sufficient low resistance values in comparison with a base material may be selected. Metals, such as Ni, Cr, Au, Mo, W, Pt, Ti, Al, Cu, and Pd, or alloys, and printed electroconductive members which include metals and metal oxides, such as Pd, Ag, Au, RuO₂, and Ag—PdO, glass and the like can be used. Alternatively, conductive particulate dispersion films in which conductive particulates made by doping particulates, which are constructed of semiconductor materials such as SnO₂, with dopants such as Sb are dispersed in an inorganic or organic binder can be used. Alternatively, it is selected from transparent conductive members, such as In₂O₃—SnO₂, and semiconductor materials, such as polysilicon suitably.

### FOURTH EMBODIMENT

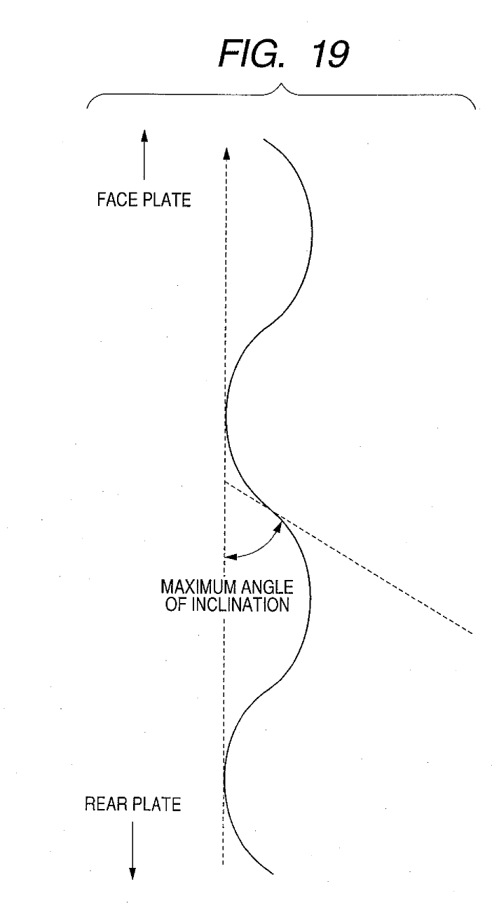

FIG. 15 is a schematic diagram illustrating a section of an embodiment of the image display device produced on the basis of the present invention. A concavo-convex range 104 where concavities and convexities are formed is formed in a main surface of a spacer 103 exposed between the rear plate and the face plate. Here, the concavities and convexities are made of a concave groove, a convex groove, or their combination which is formed in a direction approximately parallel to the rear plate and the face plate. In this embodiment, such arrangement that a maximum angle of inclination of a concavo-convex shape formed in a rear plate side becomes larger than a maximum angle of inclination of a concavo-convex shape formed in a face plate side is made. Here, the maximum angle of inclination is a maximum angle which a concavo-convex section forms with a perpendicular direction which connects the rear plate and the face plate, as illustrated in FIG. 19. In other words, the maximum angle of inclination is a maximum value of an angle between a tangent line of the spacer substrate and a normal line of the first or second substrate, and the tangent line of the spacer substrate is a tangent line on the surface of the spacer facing the first substrate. Further, the range on the first substrate side in the concavo-convex structure 106 implies the range which is on the first substrate side rather than the position at half of height of the spacer. That is, in the concavo-convex structure of the spacer, a boundary between the range on the first substrate side and the range on the second substrate side corresponds to a portion at ½ of height of the spacer. Incidentally, the portion at ½ of height of the spacer merely implies the boundary between the ranges, and the portion where the maximum angle of inclination changes need not necessarily be positioned at the position of ½ of height of the spacer. In addition, in the structure that the maximum angle of inclination gradually changes, the average of the maximum angle of inclination is calculated for each of the range on the first substrate side and the range on the second substrate side, based on the boundary at the position of ½ of height of the spacer, and the magnitudes of the averages of the respective ranges may satisfy the above relation. The high resistivity film 105 formed on a surface of the spacer 103 may be formed in order not only to specify potential of a spacer creepage surface, but also to remove charged charges. Here, an operation of the spacer with the above-mentioned construction which is a characteristic portion of the present invention will be described.

When an electron beam apparatus is driven, electrons which are given back scattering on a face plate surface collide with a spacer surface. By generating secondary electrons in the spacer surface, the electrons which collide generate charge in collision places. When concavities and convexities are formed in a surface, a charged state as illustrated in FIG. 7 according to a concavo-convex shape is formed. That is, faces opposite to the face plate or faces (top surfaces of concavities and convexities) along a normal line connecting the rear plate and the face plate are charged positively, but on the other hand, faces opposite to the rear plate are charged negatively. This is because secondary electrons generated by electrons colliding with a face opposite to the rear plate are absorbed in process of repeating re-collisions, and in other words, it is because electrons are confined in a concave portion of the concavities and convexities.

Here, when an amount of positively charged charges and an amount of negatively charged charges which are generated in one concavo-convex shape balance, their influences are canceled mutually, and hence, influences which are given to an electric field near the spacer and orbits of electrons which fly there can be suppressed.

The present inventor et al. performs investigation by detailed mathematical simulation and an experimental method regarding charge progress on a spacer surface to find out the followings regarding a distribution of charged charges on the spacer surface.

Thus, when the concavities and convexities which fulfilled a certain condition is formed on the surface of the spacer, negative charge is generated with the almost same distribution as a distribution of electrons which are incident into the spacer surface. On the other hand, positive charge is generated with the almost same distribution as a change of the secondary electron emission coefficient which is settled by potential of the spacer surface and an incident angle in each location. This is because negative charge arises in a face opposite to the rear plate by generated secondary electrons colliding with the face of the rear plate and being confined in the concavities and convexities after positive charge arises owing to collisions of electrons reflected by the face plate.

Then, by controlling an amount of the positive charge generated on the face opposite to the face plate to keep proper balance between the positive and negative charge amounts inside the concavities and convexities, even if it is a charged state, the spacer which does not have influence on a nearby electric field can be achieved.

A charge amount per collision is decided by a secondary electron emission coefficient. The secondary electron emission coefficient changes with energy and incident angles of electrons, which are incident, as illustrated in FIG. 11, and in particular, the secondary electron emission coefficient becomes large as an incident angle becomes large. That is, the generated positive charge increases. Then, when a surface is formed so that an incident angle may become small for an incident electron, the generated positive charge amount can be controlled.

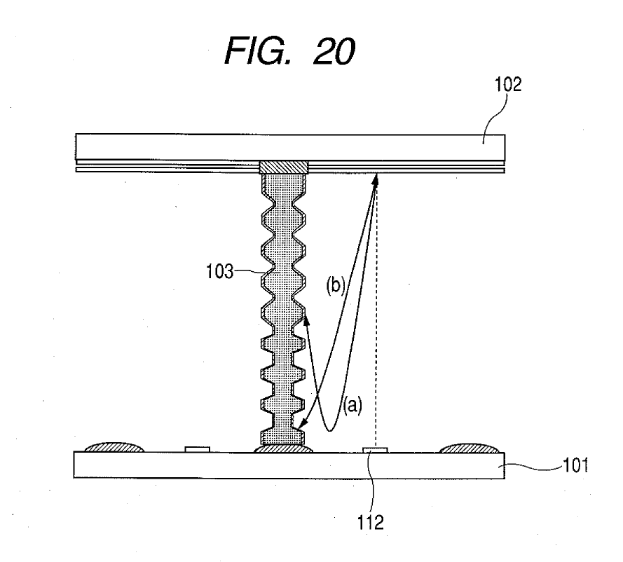

Electrons which are incident into the spacer surface fly in approximately parabolic orbits, and collide with the spacer. The orbits are roughly classified into two kinds illustrated in FIG. 20. A first one is an orbit which passes through a point of inflection of a parabola before a collision with the spacer as illustrated by (a) in FIG. 20, and an electron which collides in such an orbit collides with the spacer with having a progress component toward the face plate. On the other hand, electrons colliding without passing through a point of inflection of a parabola before a collision with the spacer as illustrated by (b) in FIG. 20, and such electrons collide with the spacer with having a progress component toward the rear plate. Among these, the electrons which collide with the face opposite to the face plate are electrons which collide with having orbits as illustrated by (b) in FIG. 20. Most of angles at which such electrons are incident into the spacer are in a range of from about 20° to 90° to a parallel line to the rear plate or the face plate although also depending on distances to a nearby electron-emitting device from the spacer. Moreover, they are distributed so that incident angles may be large as they are near to the rear plate, and incident angles may become small as they are near to the face plate.

Hence, a maximum angle of inclination of the concavo-convex portion of the spacer surface may be just set in the above-mentioned range, and the above-mentioned operation is achieved by the spacer being arranged so as to become concavities and convexities with a large inclination angle as it is near to the rear plate. Moreover, it may be sufficient that the maximum inclination angle changes gradually from the rear plate side toward the face plate side. When changing the maximum angle of inclination in consideration of the incident angle distribution of electrons which are incident into the spacer surface at this time, a more suitable operation can be obtained, which is suitable.

Since a sectional shape of the concavities and convexities can take various shapes such as an rough trapezoid (4A), a triangle (4B), a bowl shape (4C), and a rectangle (4D), as shown in FIGS. 4A to 4D, concavities and convexities having not only one kind but also a plurality of kinds of sectional shapes may be mixedly used. Incidentally, in a case where an angle of the inclination surface in one concave or convex portion is constant such as a trapezoid or a triangle (that is, in a case where the side surface is plane), the maximum angle of inclination and the angle of inclination are the same, whereby the maximum angle of inclination implies the angle of inclination.

### FIFTH EMBODIMENT

Next, a fifth embodiment of the present invention will be described.

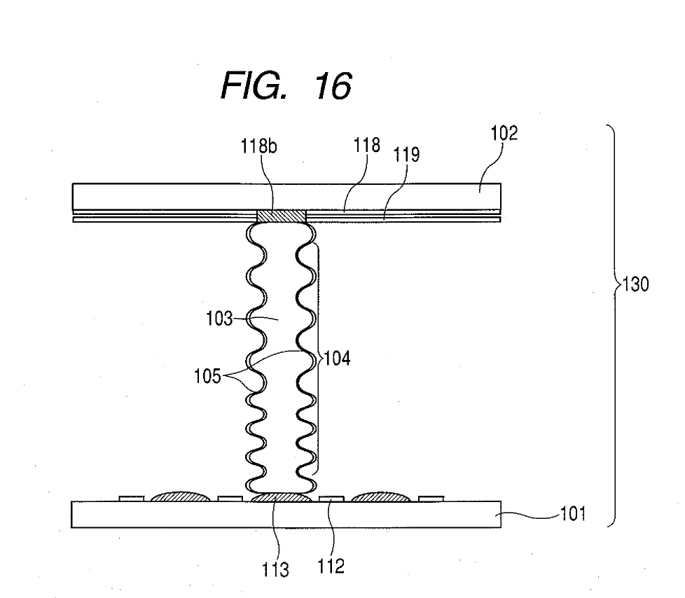

FIG. 16 is a sectional diagram of an image forming apparatus in a fifth embodiment. Reference numerals in the figure are the same as those in FIG. 1. In this second embodiment, a point that construction of the spacer 103 is different from the fourth embodiment, and since other portions are the same as those in the first embodiment, description here is omitted, and, regarding the spacer which is a feature of this embodiment, its construction and operation will be described.

As for the spacer in this embodiment, concavities and convexities are formed in the main surface, and its cycle becomes longer in the face plate side in comparison with the rear plate side. Incidentally, in a case where a period gradually changes, as well as the fourth embodiment, the average of the periods is calculated for each of the range on the first substrate side and the range on the second substrate side, based on the boundary at the position of ½ of height of the spacer, and the magnitudes of the averages of the periods may satisfy the above relation. As mentioned above, a surface of the spacer in which the concavities and convexities is formed is charged with drive of an electron beam apparatus, and positively and negatively charged charges are generated in particular in the interior of the concavities and convexities. For this reason, since mutual influences are canceled by balancing of positive and negative charge amounts, an influence given to a nearby electric field and orbits of electrons flying there can be reduced.

Nevertheless, in the vicinity of a spacer, there is a range where a change of an electric field to the extent of influencing an electron orbit is generated without the influences of the positive and negative charges being canceled. The range is nearly a gap between the positive and negative charges, that is, threefold or less, or more securely, tenfold or less of a cycle of the concavities and convexities, and the larger the gap between the positive and negative charges is (the longer a concavo-convex cycle is), the more widely the influences of the charges reach.

Here, since electrons near the rear plate are just emitted from an electron-emitting device and do not have sufficient kinetic energy, it is easy to be affected sensitively by a slight change of the electric field. On the other hand, since electrons in the face plate side have high kinetic energy, they are hard to receive the influence by disorder of an electric field. Hence, it is suitable that a gap of positive and negative charges is small, and in other words, a cycle of the concavities and convexities is shorter as approaching to the rear plate. So long as the cycle is ⅓, or more suitably, 1/10 of a distance from a spacer to a nearest electron-emitting device, influences of charges can be fully suppressed for electron orbits near the rear plate.

### SIXTH EMBODIMENT

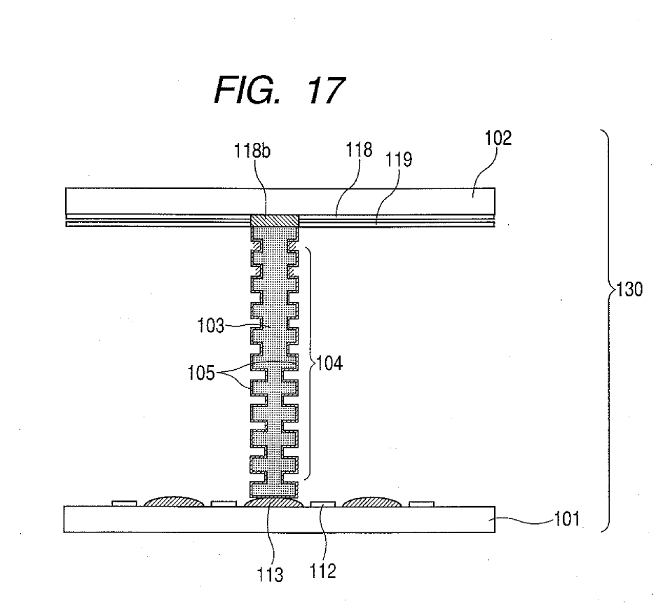

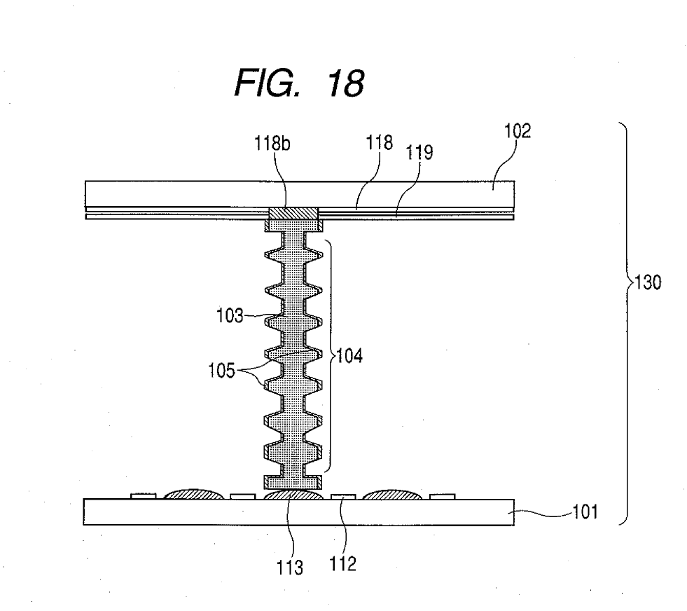

In a sixth embodiment of the present invention, as shown in FIG. 17, a depth of concavities and convexities formed in a rear plate side in a concavo-convex range formed in a main surface of a spacer is deep in comparison with that of concavities and convexities formed in a face plate side. Incidentally, in a case where the depth of concavities and convexities gradually changes, as well as the fourth embodiment, the average of the depths of concavities and convexities is calculated for each of the range on the first substrate side and the range on the second substrate side, based on the boundary at the position of ½ of height of the spacer, and the magnitudes of the averages of the periods may satisfy the above relation.

When the concavities and convexities is formed in the spacer surface as mentioned above, positive and negative charges arise inside the concavities and convexities by incident electrons being confined inside the concavities and convexities, and influences of both are cancelled, and hence, influences which they have on a nearby electric field can be reduced. Since this locked-in effect of electrons is dependent on the concavo-convex depth, a large electronic locked-in effect can be obtained as the concavities and convexities is deep.

Since electrons with low kinetic energy which are immediately after being emitted from an electron-emitting device fly in the vicinity of the rear plate, an influence which balance of positive and negative charges inside the concavities and convexities has on electron orbits is large.

As illustrated in FIG. 11, the secondary electron emission coefficient which decides charge on a spacer surface is dependent on energy at the time of an electronic collision, and has its peak in a low energy side. Hence, positive charge tends to be generated in the rear plate side. When positive charge arises in the rear plate side, electrons near the spacer fly in the further vicinity of the spacer since their orbits are deflected toward the spacer, and hence, they becomes easier to be influenced by the charge on the spacer surface and the like.

Hence, when a depth of the concavities and convexities near the rear plate is made deep in order to generate negative charge near the rear plate more securely, influences to electron orbits near the rear plate can be suppressed. In order to confine an electron which collides, a depth of 4 μm or more is suitable. On the other hand, an amount of charge is saturated in a certain depth or more. This is because negative charge is not generated over the number of incident electrons. Hence, the concavo-convex depth of 20 μm or less is suitable. In addition, similarly to the above-mentioned fifth embodiment, so long as a concavo-convex cycle is ⅓, or more suitably, 1/10 of a distance from a spacer to a nearest electron-emitting device, influences of charges can be fully suppressed for electron orbits near the rear plate.

### EXAMPLES

The present invention will be described below in detail with citing specific examples.

### Example 1

This example is an example of an image display device with construction illustrated in FIG. 1.

Spacers used in this example were produced as follows.

Glass (PD200, made by ASAHI GLASS CO., LTD.) was worked into a plate of 49.23 mm wide×300 mm long×6.15 mm thick as a base material, and grooves with roughly rectangular section were made by machining in a face of 49.23 mm×300 mm out of it. A width of a groove was decided as follows. First, a spacer which had flat surfaces without concavo-convex structure and was made of PD200 was prepared, this was irradiated with electrons accelerated at a voltage at the time of actual drive of a display apparatus, and a distribution of a secondary electron emission coefficient which became a reference was obtained.

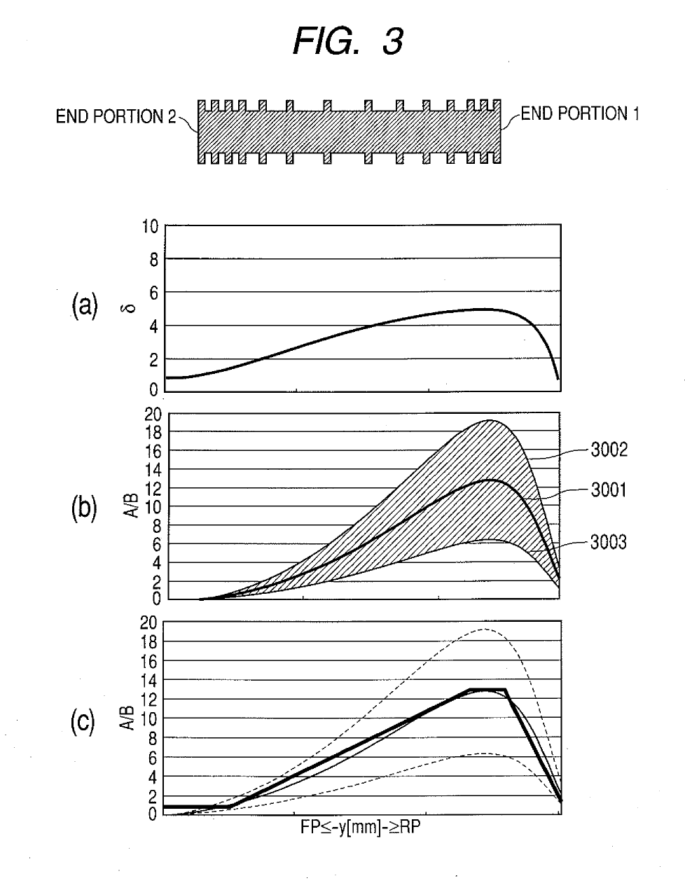

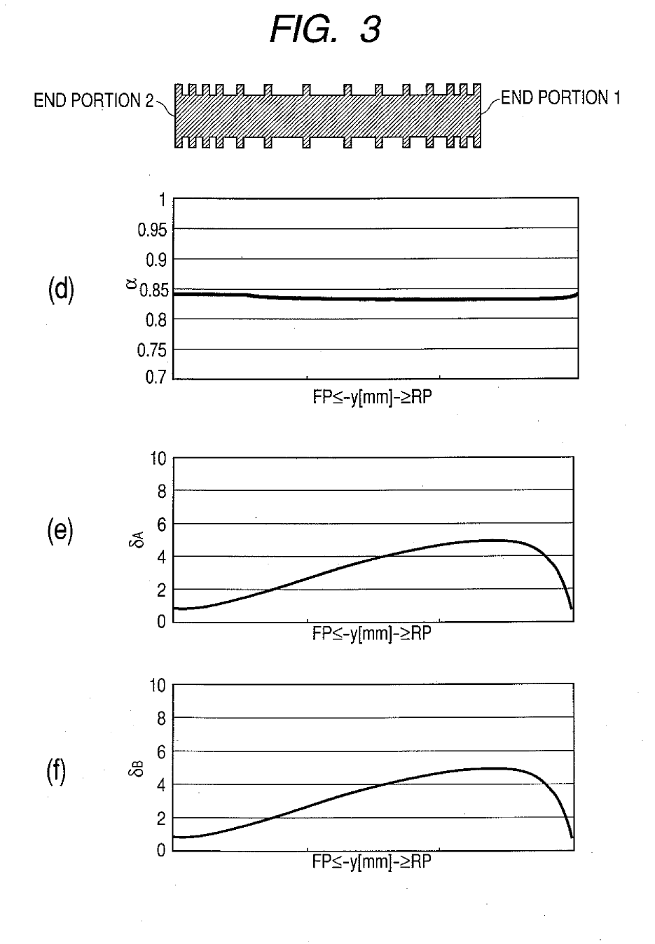

The graph (a) of FIG. 3 illustrates a distribution of a secondary electron emission coefficient δ which is obtained in this way, on the spacer surface which has a smooth surface. Here, the secondary electron emission coefficient (δ_{B}) of a convex portion of the concavo-convex spacer becomes the almost same value as a secondary electron emission coefficient δ in the graph (a) of FIG. 3. Then, a charge amount of a convex portion (portion with a length B) can be found in calculation from

q_{convex}=N_{B}(δ_{B}−1) (Formula 8)

using this distribution of the secondary electron emission coefficient δ. A length A necessary for generating a charge amount equivalent to the charge amount of the convex portion in a concave portion (portion with a length A) on the basis of this value is calculated, and the graph (b) of FIG. 3 is a distribution of the calculated concavo-convex ratio A/B.

In the graph (b) of FIG. 3, reference numeral 3001 denotes a concavo-convex ratio at which an effectual charge amount in concavo-convex structure becomes zero, and reference numeral 3002 denotes a concavo-convex ratio at which negative charge increases by 50% than positive charge. In addition, reference numeral 3003 denotes a concavo-convex ratio at which positive charge increases by 50% than negative charge.

A distribution of the concavo-convex ratio as illustrated in the graph (c) of FIG. 3 from here was decided. At that time, a width B of the portion (convex portion), which was not cut, between grooves was made into 0.15 mm, and a width A of the groove was decided on the basis of the relation mentioned above. A depth of the groove was made into 0.3 mm for all the grooves. In an area whose distance from one end portion 1 was 6.7 mm to 11.5 mm is and whose width is 4.8 mm, such concavo-convex structure that A/B=13, that is, A=1.95 mm was made. In addition, in an area whose distance from another end portion (this was made an end portion 2) was 8.1 mm was and in which a width of a groove was 0.15 mm, such concavo-convex structure that A/B=1, that is, A=0.15 mm was made. An intermediate area other than this was worked so that the A/B might change gradually according to a profile illustrated in the graph (c) of FIG. 3.

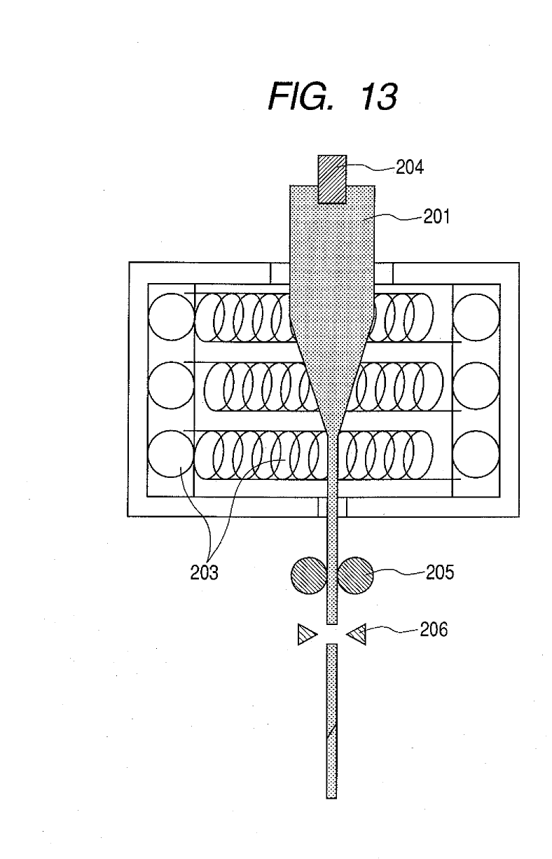

A spacer substrate was produced by performing heating drawing of this parent material on the following conditions using an apparatus as illustrates n FIG. 13.

In FIG. 13, reference numeral 204 denotes a mechanical chuck, reference numeral 205 denotes a receiving roller, and reference numeral 203 denotes a heater.

The parent material 201 was sent into the heater 203 by lowering the mechanical chuck, fixing the parent material 201, at the rate of 2.5 mm/min, and was heated at 790° C. by the heater 203. The spacer substrate which had a sectional shape roughly similar to that of the parent material was obtained by performing drawing by receiving it at the rate of 2700 mm/min by the receiving roller 205 arranged under the heater 203 with performing this heating. At this time, an unnecessary warpage and the like of the spacer substrate were not seen.

The obtained spacer substrate was 1.6 mm wide and 0.2 mm thick, and was cut using a cutter 206 so that a length might become 800 mm. In the 1.6×800 mm main surface of the obtained spacer, a concavo-convex shape having a roughly rectangular section with a groove width of 55 μm, and A/B=13 in an area with a width of 0.16 mm of 0.22 mm or more and 0.38 mm or less from the end portion 1 was formed. In addition, concavo-convex structure having a roughly rectangular section with a groove width of 5 μm, and A/B=1 was formed in an area apart 0.27 mm from the end portion 2. Respective rectangular grooves were formed with their groove width changing gradually also in an area other than it (refer to the graph (c) of FIG. 3). A depth of grooves in all the concavo-convex structure was 10 μm. An electron confinement probability α in a concave portion of the concavo-convex structure of the spacer obtained in this way becomes 0.8 or more throughout the spacer as illustrated in the graph (d) of FIG. 3. In addition, the graphs (e) and (f) of FIG. 3 illustrate actual measurements of δA and δB, respectively.

Subsequently, after cleaning the obtained spacer, it was fixed on the rear plate 101 prepared separately. The spacer 103 was arranged so that the end portion 1 might abut on the row-directional wiring 113 in a rear plate 101 side, and it was fixed with a block for position fixation (not shown in FIG. 1) in the end portion in a longitudinal direction. A gap between row-directional wirings is 600 μm.

The block for fixing the spacer 103 was produced by cutting glass (PD200) similarly to the spacer 103. The block had a shape of a rectangular solid with 4 mm×5 mm×1 mm thick, and a 210-μm-wide groove was formed in its side face so that a longitudinal-direction end portion of the spacer 103 could be inserted. When installing in a panel, after being adjusted lest the spacer 103 should incline aslant to the face plate 102 or the electron source substrate 101, the spacer 103 and the block were fixed mutually with a ceramic-based adhesive.

Then, with the face plate 102 and the side wall 1016 which were produced separately, an envelope was formed and evacuation and formation of an electron source were performed. By performing sealing after this, the spacer was completely fixed in a predetermined position in a panel by atmospheric pressure applied from outside the envelope.

In the image display device using the above-mentioned display panel as illustrated in FIG. 5, a scan signal and a modulating signal were applied respectively to each cold cathode device (surface conduction emitting-device) 112 from ex-vessel terminals Dx1 to Dxm, and Dy1 to Dyn by signal generating unit not shown. Thereby, electrons were emitted. An image was displayed by accelerating an emitted electron beam by applying a high voltage to the metal back 119 through a high-voltage terminal Hv, and making electrons collide with the fluorescent member film 118 to let each color fluorescence to be excited and to emit light. In addition, the applied voltage Va to the high-voltage terminal Hv was set at 13 kV, and an applied voltage Vf between respective wirings 113 and 114 was set at 18 V. In addition, a pulse width which drives a device was set in 0.5 to 20 μs, and a drive frequency was 60 Hz. In addition, a gap between the rear plate and the face plate is 1.6 mm which is the same as the width of the spacer.

When observing a position of a light-emitting spot by electrons emitted from an electron-emitting device (hereinafter, a nearest device) 112, which was nearest to the spacer 103, in a state of driving the image forming apparatus in detail for every driving pulse width, a change of the position of the light-emitting spot by the driving pulse width was 4 μm. This was 0.16% to the gap between row-directional wirings, and a positional offset of a beam spot was not recognized but could display a very good image.

### Comparative Example 1-1

As a comparative example 1-1, a spacer in which an A/B was 1 in all the concavo-convex structure was produced by the same method as that in the first example. At this time, a groove width was 15 μm.

An image forming apparatus was produced by the same method as that in the first example using the produced spacer, and similarly to the first example, a position of a light-emitting spot by electrons emitted from an electron-emitting device nearest to the spacer for every driving pulse width was observed in detail. In consequence, an aspect that the position of the light-emitting spot was displaced by about 30 μm in a direction approaching the spacer as the driving pulse width becomes wide was observed. This is equivalent to 5% of a row-directional wiring gap. Since it is displaced in the direction approaching the spacer, it turns out that charge on a spacer surface approaches a positive charge side. When the drive was further continued, discharge arose in a spacer creepage surface. Hence, the spacer in the comparative example 1-1 cannot be suitably used as a spacer of an image display device.

### Comparative Example 1-2

As a comparative example 1-2, such a spacer that the A/B became 13 in all the concavo-convex structure was produced by the same method as that in the first example. In this comparative example 1-2, a groove width of all the concavo-convex structure was 65 μm.

An image forming apparatus was produced by the same method as that in the first example using the produced spacer, and similarly to the first example, a position of a light-emitting spot by electrons emitted from an electron-emitting device nearest to the spacer for every driving pulse width was observed in detail. In consequence, an aspect that the position of the light-emitting spot was displaced by about 20 μm in a direction separating from the spacer as the driving pulse width becomes wide was observed. Since it is displaced in the direction separating from the spacer, it turns out that charge on a spacer surface approaches a negative charge side. A displacement amount of the spot in this comparative example is an amount equivalent to 3% of the row-directional wiring gap, and a displacement amount of the light-emitting spot is recognizable, and hence, this cannot be used suitably as an image display device.

### Comparative Example 1-3

As a comparative example 1-3, a spacer which had not only a distribution of the concavo-convex ratio A/B similar to that in the first example in all the concavo-convex structure, but also a 4-μm depth in all the concavo-convex structure was produced by the same method as that in the first example.

An image forming apparatus was produced by the same method as that in the first example using the produced spacer, and similarly to the first example, a position of a light-emitting spot by electrons emitted from an electron-emitting device nearest to the spacer for every driving pulse width was observed in detail. In consequence, an aspect that the position of the light-emitting spot was displaced by about 25 μm in a direction approaching the spacer as the driving pulse width becomes wide was observed. Since it is displaced in the direction approaching the spacer, it turns out that charge on a spacer surface approaches a positive charge side. This corresponds to a ratio of electrons confined in a concave portion decreasing. A displacement amount of the spot in this comparative example is an amount equivalent to 4% of the row-directional wiring gap, and a displacement amount of the light-emitting spot is recognizable, and hence, this cannot be used suitably as an image display device.

### Example 2

In this embodiment, a spacer that a high resistivity film (details will be mentioned later) was formed on a surface of an insulating base material was produced, and an image forming apparatus was produced using it.

The spacer used in this example was produced as follows.

First, glass (PD200, made by ASAHI GLASS CO., LTD.) was worked into a plate of 49.23 mm wide×300 mm long×6.15 mm thick as a base material, and grooves with roughly trapezoidal section were made by machining in a face of 49.23 mm×300 mm out of it. A width of a groove was decided as follows on the basis of a distribution of a secondary electron emission coefficient on a spacer surface which was calculated using the secondary electron emission coefficient of an high resistivity film having measured separately.

The graph (a) of FIG. 9 illustrates a distribution of the secondary electron emission coefficient d on the spacer surface which is found using the secondary electron emission coefficient measured. The graph (b) of FIG. 9 illustrates a distribution of the concavo-convex ratio A/B calculated from this distribution of the secondary electron emission coefficient δ. In the graph (b) of FIG. 9, reference numeral 3001 denotes a concavo-convex ratio at which an effectual charge amount in concavo-convex structure becomes zero, and reference numeral 3002 denotes a concavo-convex ratio at which negative charge increases by 50% than positive charge. In addition, reference numeral 3003 denotes a concavo-convex ratio at which positive charge increases by 50% than negative charge.

A distribution of the concavo-convex ratio as illustrated in the graph (c) of FIG. 9 from here was decided. At that time, the width B of the portion (convex portion), which was not cut, between grooves was made into 0.15 mm, and the width A of the groove was decided on the basis of the relation mentioned above. A depth of the groove was made into 0.3 mm for all the grooves. In an area whose distance from one end portion 1 was 14.4 mm to 21.6 mm was and whose width was 7.2 mm, such concavo-convex structure that A/B=11, that is, A=1.65 mm was made. In addition, in an area whose distance from another end portion (this was made the end portion 2) was 6.7 mm, a width A of a groove was worked so that A/B=1, that is, it may become 0.15 mm. An intermediate area other than this was worked so that the A/B might change gradually according to a profile illustrated in the graph (c) of FIG. 9.

A spacer substrate was produced by performing heating drawing of this parent material on the following conditions using an apparatus as illustrated in FIG. 13.

In FIG. 13, reference numeral 204 denotes a mechanical chuck, reference numeral 205 denotes a receiving roller, and reference numeral 203 denotes a heater.

The parent material 201 was sent into the heater 203 by lowering the mechanical chuck, fixing the parent material 201, at the rate of 2.5 mm/min, and was heated at 790° C. by the heater 203. The spacer substrate which had a sectional shape roughly similar to that of the parent material was obtained by performing drawing by receiving it at the rate of 2700 mm/min by the receiving roller 205 arranged under the heater 203 with performing this heating. At this time, an unnecessary warpage and the like of the spacer substrate were not seen.

The obtained spacer substrate was 1.6 mm wide and 0.2 mm thick, and was cut using the cutter 206 so that a length might become 800 mm.

In the 1.6×800 mm main surface of the obtained spacer, a concavo-convex shape having a roughly trapezoidal section with a groove width of 55 μm, and A/B=11 in an area with a width of 0.24 mm of 0.48 mm or more and 0.72 mm or less from the end portion 1 was formed. In addition, concavo-convex structure having a roughly trapezoidal section with a groove width of 5 μm, and A/B=1 was formed in an area apart 0.22 mm from the end portion 2. Respective trapezoidal grooves were formed with their groove width changing gradually also in an area other than it. A depth of grooves in all the concavo-convex structure was 15 μm. As for a shape, FIGS. 10A and 10B are referred to.

Next, the spacer substrate which was produced in this way was cleaned, and a nitride film of W and Ge was formed by a vacuum forming-film method as a high resistivity film on the cleaned spacer substrate.

The nitride film of W and Ge used in this example was formed by sputtering W and Ge targets at the same time in a mixed ambient atmosphere of argon and nitrogen using a sputtering apparatus. At the time of film formation, a resistance value of the high resistivity film was controlled by changing conditions of sputtering. In addition, the resistance value of the high resistivity film was performed by adjusting a dosage of W by controlling input power to the W and Ge targets and sputtering time. The obtained high resistivity film was about 200 nm in thickness, and sheet resistance value was 3×10¹¹ Ω/square.

Subsequently, the obtained spacer was fixed on the rear plate 101 prepared separately. Here, the spacer 103 on which the high resistivity film was formed was arranged on the row-directional wiring 113 in a rear plate 101 side after arranged so that the end portion 1 side might be located in the rear plate 101 side, and it was fixed with a block for position fixation (not shown in FIG. 1) in the end portion in a longitudinal direction.

The block for fixing the spacer 103 was produced by cutting glass (PD200) similarly to the spacer 103. The block had a shape of a rectangular solid with 4 mm×5 mm×1 mm thick, and a 210-μm-wide groove was formed in its side face so that a longitudinal-direction end portion of the spacer 103 could be inserted. When installing in a panel, after being adjusted lest the spacer 103 should incline aslant to the face plate 102 or the electron source substrate 101, the spacer 103 and the block were fixed mutually with a ceramic-based adhesive.

Then, with the face plate 102 and the side wall 116 which were produced separately, an envelope was formed and evacuation and formation of an electron source were performed. By performing sealing after this, the spacer was completely fixed in a predetermined position in a panel by atmospheric pressure applied from outside the envelope.

In the image display device using the above-mentioned display panel as illustrated in FIG. 5, a scan signal and a modulating signal were applied respectively to each cold cathode device (surface conduction emitting-device) 112 from ex-vessel terminals Dx1 to Dxm, and Dy1 to Dyn by signal generating unit not shown. Thereby, electrons were emitted. An image was displayed by accelerating an emitted electron beam by applying a high voltage to the metal back 119 through a high-voltage terminal Hv, and making electrons collide with the fluorescent member film 118 to let each color fluorescence to be excited and to emit light. In addition, the applied voltage Va to the high-voltage terminal Hv was set at 13 kV, and an applied voltage Vf between respective wirings 113 and 114 was set at 18 V. In addition, a pulse width which drives a device was set in 0.5 to 20 μs, and a drive frequency was 60 Hz.

When observing a position of a light-emitting spot by electrons emitted from an electron-emitting device 112, which was nearest to the spacer 103, in a state of driving the image forming apparatus in detail for every driving pulse width, a change of the position of the light-emitting spot by the driving pulse width was 2 μm. It could be confirmed that this was 0.1% or less to the gap between row-directional wirings, and a positional offset of a beam spot was not recognized but could display a very good image.

### Comparative Example 2-1

As a comparative example 2-1, a spacer in which an A/B was 1 in all the concavo-convex structure was produced by the same method as that in the second example. At this time, a groove width was made into 15 μm for all the grooves.

An image forming apparatus was produced by the same method as that in the second example using the produced spacer, and similarly to the second example, a position of a light-emitting spot by electrons emitted from an electron-emitting device nearest to the spacer for every driving pulse width was observed in detail. In consequence, an aspect that the position of the light-emitting spot was displaced by about 20 μm in a direction approaching the spacer as the driving pulse width becomes wide was observed. This is equivalent to 3% of a row-directional wiring gap. Since it is displaced in the direction approaching the spacer, it turns out that charge on a spacer surface approaches a positive charge side. When the drive was further continued, discharge arose in a spacer creepage surface. Hence, the spacer in the comparative example 2-1 generated discharge on the creepage surface of the image display device. Hence, it could be confirmed that the spacer in the comparative example 2-1 could not be suitably used as a spacer of the image display device.

### Comparative Example 2-2

As a comparative example 2-2, such a spacer that the A/B became 11 in all the concavo-convex structure was produced by the same method as that in the second example. In this comparative example 2-2, a groove width of all the concavo-convex structure is 55 μm.

An image forming apparatus was produced by the same method as that in the second example using the produced spacer, and similarly to the second example, a position of a light-emitting spot by electrons emitted from an electron-emitting device nearest to the spacer for every driving pulse width was observed in detail. In consequence, an aspect that the position of the light-emitting spot was displaced by about 20 μm in a direction separating from the spacer as the driving pulse width becomes wide was observed. Since it is displaced in the direction separating from the spacer, it turns out that charge on a spacer surface approaches a negative charge side. A displacement amount of the spot in this comparative example is an amount equivalent to 3% of the row-directional wiring gap, and a displacement amount of the light-emitting spot is recognizable, and hence, this cannot be used suitably as an image display device.

### Comparative Example 2-3

As a comparative example 2-3, a spacer which had not only a distribution of the concavo-convex ratio A/B similar to that in the second example in all the concavo-convex structure, but also a 6-μm depth in all the concavo-convex structure was produced by the same method as that in the second example.

An image forming apparatus was produced by the same method as that in the second example using the produced spacer, and similarly to the second example, a position of a light-emitting spot by electrons emitted from an electron-emitting device nearest to the spacer for every driving pulse width was observed in detail. In consequence, an aspect that the position of the light-emitting spot was displaced by about 15 μm in a direction approaching the spacer as the driving pulse width becomes wide was observed. Since it is displaced in the direction approaching the spacer, it turns out that charge on a spacer surface approaches a positive charge side. This corresponds to a ratio of electrons confined in a concave portion decreasing. It was confirmed that a displacement amount of the spot in this comparative example is an amount equivalent to 2.5% of the row-directional wiring gap, and a displacement amount of the light-emitting spot is recognizable, and hence, this could not be used suitably as an image display device.

### Example 3

In this example, a spacer that concavo-convex structure was formed on a surface of a conductive base material by machining was formed was produced, and an image forming apparatus was produced using it.

The spacer used in this example was produced as follows.

Golden particles, having a predetermined grain size which was in a range of 0.5 nm to 50 μm, as powder of conductive particles, and glass powder having a predetermined grain size of 50 μm or less according to the grain size of golden particles as an insulating base material were prepared. A conductive member was produced by performing mixed preparation so that the volume fraction of golden particles to the whole base material might become 50 vol % or less to perform baking at 800 to 1500° C.

Volume resistivity was measured by installing this conductive member into a vacuum and applying a predetermined electric field (0.01 to 1000 V/mm). Temperature characteristics of resistance were measured together by performing 200° C. heating-cooling at the time of measuring resistance.

An average particle diameter of the golden particles dispersed in the conductive member was found using a TEM (transmission electron microscope) and a SEM (scanning electron microscope). In consequence, a conductive member that golden grain size was 0.5 nm to 50 μm, the volume fraction of golden particles to the whole base material was 50 Vol % or less, and volume resistivity p=1×10⁵ Ωcm or more was obtained.

This conductive member was cut and worked into a thin plate of 1.6 mm wide, 0.2 mm thick, and 100 mm long.

Next, grooves with roughly rectangular section were made by machining in a face of 1.6 mm×100 mm. A width of a groove was decided on the basis of a distribution of a secondary electron emission coefficient on a spacer surface which was calculated using the secondary electron emission coefficient of a conductive base material having measured separately. At that time, the width B of the portion (convex portion), which was not cut, between grooves was made into 10 μm, and the width A of the groove was decided on the basis of the relation mentioned above. A depth of the groove was made into 10 μm for all the grooves. As for a groove width, an area whose distance from one end portion (this was made into the end portion 1) was 0.4 mm to 0.8 mm was and whose width was 0.4 mm was made so that A/B=8, that is, A=80 μm. In addition, an area whose distance from another end portion (this was made the end portion 2) was 0.1 mm was worked so that A/B=1, that is, a width A of the groove may become 10 μm. An intermediate area other than this was worked so that A/B might change gradually.

Subsequently, it was arranged and fixed to the rear plate produced separately so that it might abut on the row-directional wiring on the rear plate in a side where a concavo-convex depth of the spacer substrate was deep. At that time, it was electrically connected with row-directional wiring using conductive glass frit.

Furthermore, with the face plate 102 and the side wall 116 which were produced separately, an envelope was formed and evacuation and formation of an electron source were performed. By performing sealing after this, the spacer was completely fixed in a predetermined position in a panel by atmospheric pressure applied from outside the envelope, and an image forming apparatus was produced.

In the image display device completed as mentioned above, a scan signal and a modulating signal were applied respectively to each cold cathode device (surface conduction emitting-device) 112 from ex-vessel terminals Dx1 to Dxm, and Dy1 to Dyn by signal generating unit not shown, and thereby, electrons were emitted. An image was displayed by accelerating an emitted electron beam by applying a high voltage to the metal back 119 through a high-voltage terminal Hv, and making electrons collide with the fluorescent member film 118 to let each color fluorescence to be excited and to emit light. In addition, the applied voltage Va to the high-voltage terminal Hv was set at 13 kV, and an applied voltage Vf between respective wirings 113 and 114 was set at 18 V. In addition, a pulse width which drives a device was set in 0.5 to 20 μs, and a drive frequency was 60 Hz.

When observing a position of a light-emitting spot by electrons emitted from an electron-emitting device 112, which was nearest to the spacer 103, in a state of driving the image forming apparatus in detail for every driving pulse width, a change of the position of the light-emitting spot by the driving pulse width was 2 μm. It could be confirmed that this was 0.1% or less to the gap between row-directional wirings, and a positional offset of a beam spot was not recognized but could display a very good image.

### Comparative Example 3-1

As a comparative example 3-1, a spacer in which an A/B was 1 in all the concavo-convex structure was produced by the same method as that in the third example. At this time, a groove width was made into 10 μm for all the grooves.

An image forming apparatus was produced by the same method as that in the third example using the produced spacer, and similarly to the third example, a position of a light-emitting spot by electrons emitted from an electron-emitting device nearest to the spacer for every driving pulse width was observed in detail. In consequence, an aspect that the position of the light-emitting spot was displaced by about 20 μm in a direction approaching the spacer as the driving pulse width becomes wide was observed. This is equivalent to 3% of a row-directional wiring gap. Since it is displaced in the direction approaching the spacer, it turns out that charge on a spacer surface approaches a positive charge side. It could be confirmed that the spacer in the comparative example 3-1 could not be suitably used as a spacer.

### Comparative Example 3-2

As a comparative example 3-2, such a spacer that the A/B became 8 in all the concavo-convex structure was produced by the same method as that in the third example. In this comparative example 3-2, a groove width of all the concavo-convex structure is 55 μm.

An image forming apparatus was produced by the same method as that in the third example using the produced spacer, and similarly to the third example, a position of a light-emitting spot by electrons emitted from an electron-emitting device nearest to the spacer for every driving pulse width was observed in detail. In consequence, an aspect that the position of the light-emitting spot was displaced by about 18 μm in a direction separating from the spacer as the driving pulse width becomes wide was observed. Since it is displaced in the direction separating from the spacer, it turns out that charge on a spacer surface approaches a negative charge side. A displacement amount of the spot in this comparative example is an amount equivalent to 3% of the row-directional wiring gap, and a displacement amount of the light-emitting spot is recognizable, and hence, this cannot be used suitably as an image display device.

### Comparative Example 3-3

As a comparative example 3-3, a spacer which had not only a distribution of the concavo-convex ratio A/B similar to that in the third example in all the concavo-convex structure, but also a 4-μm depth in all the concavo-convex structure was produced by the same method as that in the third example.

An image forming apparatus was produced by the same method as that in the third example using the produced spacer, and similarly to the third example, a position of a light-emitting spot by electrons emitted from an electron-emitting device nearest to the spacer for every driving pulse width was observed in detail. In consequence, an aspect that the position of the light-emitting spot was displaced by about 25 μm in a direction approaching the spacer as the driving pulse width becomes wide was observed. Since it is displaced in the direction approaching the spacer, it turns out that charge on a spacer surface approaches a positive charge side. This corresponds to a ratio of electrons confined in a concave portion decreasing. It was confirmed that a displacement amount of the spot in this comparative example is an amount equivalent to 4% of the row-directional wiring gap, and a displacement amount of the light-emitting spot is recognizable as disorder of an image, and hence, this could not be used suitably as an image display device.

### Example 4

### Angle Distribution

This example is an example of an electron beam apparatus with construction illustrated in FIG. 15.

Spacers used in this example were produced as follows. As a parent material, glass (PD200, made by ASAHI GLASS CO., LTD.) was worked into a plate of 49.23 mm wide (corresponding to a Z direction in FIG. 5)×300 mm long (corresponding to an X direction in FIG. 5)×6.15 mm thick (corresponding to a Y direction in FIG. 5). Fifty-two lines of grooves with roughly trapezoidal section were made by machining in a face of 49.23 mm×300 mm out of it. Angles of slopes of a trapezoid groove were 30° in an area with a width of 15 mm in one end portion side, and 70° in the remaining area. A spacer base material was produced by performing heating drawing of this parent material on the following conditions using an apparatus as illustrates n FIG. 13. In FIG. 13, reference numeral 204 denotes a mechanical chuck, reference numeral 205 denotes a receiving roller, and reference numeral 203 denotes a heater. The parent material 201 was sent into the heater 203 by lowering the mechanical chuck, fixing the parent material 201, at the rate of 2.5 mm/min. Subsequently, the spacer base material which had a sectional shape roughly similar to that of the parent material was obtained by performing heating drawing by receiving it at the rate of 2700 mm/min by the receiving roller 205 arranged under the heater 203 with heating it to 790° C. with the heater 203. At this time, an unnecessary warpage and the like of the spacer base material were not seen. The obtained spacer base material was 1.6 mm wide and 0.2 mm thick, and was cut using the cutter 206 so that a length might become 800 mm. Roughly, trapezoidal concavities and convexities with a depth of 10 μm and a cycle of 30 μm are formed in the 1.6×800 mm main surface of the obtained spacer, and their maximum angles of inclination were 25° in an area with 480 μm in one end portion side, and 65° in the remaining area.

Next, the spacer base material which was produced in this way was cleaned, and a nitride film of W and Ge was formed by a vacuum forming-film method as a high resistivity film on the cleaned spacer base material.

The nitride film of W and Ge used in this example was formed by sputtering W and Ge targets at the same time in a mixed ambient atmosphere of argon and nitrogen using a sputtering apparatus. At the time of film formation, a resistance value of the high resistivity film was controlled by changing conditions of sputtering. In addition, the resistance value of the high resistivity film was performed by adjusting a dosage of W by controlling input power to the W and Ge targets and sputtering time. The obtained high resistivity film was about 200 nm in thickness, and sheet resistance value was 3×10¹¹ Ω/square.

Subsequently, the obtained spacer was fixed on the rear plate 101 prepared separately. As shown in FIGS. 15 and 5, the spacer 103 in which the high resistivity film 105 was formed was arranged so that the area where a maximum angle of inclination of the concavities and convexities was large may be located in the rear plate 101 side, and thereafter, it was arranged on the row-directional wiring 113 in the rear plate 101 side. In an end portion in a longitudinal direction, it was fixed with a block for position fixation (not shown in FIG. 15). The block for fixing the spacer 103 was produced by cutting glass (PD200) similarly to the spacer 103. The block had a shape of a rectangular solid with 4 mm×5 mm×1 mm thick, and a 210-μm-wide groove was formed in its side face so that a longitudinal-direction end portion of the spacer 103 could be inserted. When installing in a panel, after being adjusted lest the spacer 103 should incline aslant to the face plate 102 or the electron source substrate 101, the spacer 103 and the block were fixed mutually with a ceramic-based adhesive.

Then, with the face plate 102 and the side wall 106 which were produced separately, an envelope was formed and evacuation and formation of an electron source were performed. By performing sealing after this, the spacer was completely fixed in a predetermined position in a panel by atmospheric pressure applied from outside the envelope.

In the image display device which was completed in this way and uses the above-mentioned display panel as illustrated in FIG. 5, a scan signal and a modulating signal were applied respectively to each electron-emitting device 112 through ex-vessel terminals Dx1 to Dxm, and Dy1 to Dyn from signal generating unit not shown. Thereby, electrons are emitted. On the other hand, an image was displayed by accelerating an emitted electron beam by applying a high voltage to the metal back 119 through a high-voltage terminal Hv, and making electrons collide with the fluorescent member film 118 to let each color fluorescence to be excited and to emit light. In addition, the applied voltage Va to the high-voltage terminal Hv was set in a rage of 5 kV to 13 kV, and an applied voltage Vf between respective wirings 113 and 114 was set at 18 V. In addition, a pulse width which drives a device was set in 0.5 to 20 μs inclusive, and a drive frequency was 60 Hz.

When observing a position of a light-emitting spot by electrons emitted from an electron-emitting device 112, which was nearest to the spacer 103, in a state of driving the image forming apparatus in detail for every driving pulse width, a change of the position of the light-emitting spot by the driving pulse width was 10 μm or less.

On the other hand, a spacer that maximum angles of inclination were equal in all the concavo-convex shape was produced as a comparative example by the same method, and similarly to the example, a position of a light-emitting spot by electrons emitted from an electron-emitting device nearest to the spacer for every driving pulse width was observed in detail. In consequence, since an aspect that the position of the light-emitting spot was displaced by about 28 μm as the driving pulse width becomes wide was observed, validity and predominancy of the present invention of suppressing an influence of charge under drive could be confirmed.

### Example 5

In this example, an image forming apparatus in which a spacer which had a concavo-convex range where a maximum angle of inclination changed from a rear plate side gradually toward a face plate side was arranged was produced. A concavo-convex range where a maximum angle of inclination changed gradually in a range of 30° to 80° inclusive was formed in a main surface of the produced spacer base material. The maximum angle of inclination of individual concavity and convexity is decided so that an incident angle of an electron which is incident there may become approximately 0° (almost perpendicularly entering) in each position of a spacer surface, and it has a distribution mostly as illustrated in FIG. 22. In addition, in the figure, the groove number on a horizontal axis is the number of a groove counted from one end portion of a lateral direction (corresponding to a width) of the spacer, and is plotted from 1 to 52 (in this example, the number of grooves is 52). A sectional shape of concavities and convexities is a rough trapezoid. A concavo-convex depth was 10 μm and a cycle was 30 μm. After concavities and convexities were formed in the parent material of glass (PD200) by cutting similarly to the fourth example, the spacer was produced by performing a heating drawing step. The size of the obtained spacer base material was 1.6 mm×800 mm×0.2 mm. In addition, a stable spacer base material could be formed also in this example without an unnecessary warpage and the like arising in the base material after drawing.

After the obtained spacer base material was cleaned and thereafter, film formation of a high resistivity film was performed, it was arranged so that the side whose maximum angle of inclination is 80° may become the rear plate side, and was fixed on the rear plate. In addition, in this example, construction of those other than the spacer is the same as that of the first example.

When performed the same evaluation as that in the fourth example using the produced image forming apparatus, similarly to the fourth example, displacement of a position of a nearest light-emitting spot by a driving pulse width was 5 μm or less, and a suppressing effect of an influence by charge improved in comparison with a case of the fourth example.

### Example 6

In this example, as shown in FIG. 16, an image forming apparatus using a spacer that a concavo-convex cycle becomes longer in a face plate side in comparison with a rear plate side was produced.

Size of the spacer base material produced using the heating drawing method similarly to the fourth example was 1.6 mm×800 mm×0.2 mm. A stable spacer base material could be formed also in this example without an unnecessary warpage and the like arising in the base material after drawing.

A sectional shape of the concavities and convexities formed in a main surface of the spacer base material was a bowl shape, a depth was 10 μm, a maximum angle of inclination was 60°, and a cycle is 30 μm in an area which is 50% in a lateral direction (direction (width) opposite to the first substrate and the second substrate) of the main surface and was 50 μm in the residual 50% of area.

After the obtained spacer was cleaned and thereafter, film formation of a high resistivity film was performed, it was arranged so that the side where a convex-concave cycle was 30 μm might become a side abutting on the rear plate, and was aligned to be fixed on the rear plate having been separately prepared. On the rear plate used in this example, electron-emitting devices are formed in the pitch of 450 μm, and a distance to a nearest electron-emitting device is 125 μm.

Furthermore, with the face plate 102 and a side wall which had been produced separately, an envelope was formed, and evacuation and formation of an electron source were performed. By performing sealing after this, the spacer was completely fixed in a predetermined position in a panel by atmospheric pressure applied from outside the envelope, and an image forming apparatus was produced.

When the same evaluation as that in the fourth example was performed using the produced image forming apparatus, displacement of a position of a nearest light-emitting spot by a driving pulse width was 4 μm.

On the other hand, a spacer that all the concavo-convex structure with a cycle of 50 μm were formed was produced as a comparative example by the same method, and similarly to the example, a position of a light-emitting spot by electrons emitted from an electron-emitting device nearest to the spacer for every driving pulse width was observed in detail. In consequence, since an aspect that the position of the light-emitting spot was displaced by about 15 μm as the driving pulse width becomes wide was observed, validity and predominancy of the present invention of suppressing an influence of charge under drive could be confirmed.

### Example 7

In this embodiment, an image forming apparatus using a spacer that a concavo-convex cycle became gradually longer to a face plate side from a rear plate side was produced.

Using the heating drawing method similarly to the sixth example, a spacer base material which had concavities and convexities with a bowl-shaped section produced on its surface. The size of the obtained spacer base material was 1.6 mm×800 mm×0.2 mm.

A depth of the formed concavities and convexities was 10 μm, a maximum angle of inclination was 60° to 65°, and its cycle was made to become long by 0.7 μm every cycle from 20 μm to 50 μm. A total of 44 concavities and convexities was formed. In addition, a stable spacer base material could be formed also in this example without an unnecessary warpage and the like arising in the base material after drawing.

After the obtained spacer was cleaned and thereafter, film formation of a high resistivity film was performed, it was arranged so that a side where a convex-concave cycle was short might become a side abutting on the rear plate, and was aligned to be fixed on the rear plate having been separately prepared. On the rear plate also in this example, electron-emitting devices are formed in the pitch of 450 μm, and a distance to a nearest electron-emitting device is 125 μm.

Here, with the face plate 102 and a side wall which had been produced separately, an envelope was formed, and evacuation and formation of an electron source were performed. By performing sealing after this, the spacer was completely fixed in a predetermined position in a panel by atmospheric pressure applied from outside the envelope, and an image forming apparatus was obtained. When performed the same evaluation as that in the sixth example using the produced image forming apparatus, displacement of a position of a nearest light-emitting spot by a driving pulse width was 3 μm, and it was confirmed that a suppressing effect of an influence by charge improved in comparison with a case of the fourth example. In addition, construction of combining the fourth or fifth example, and this example or the sixth example is also possible, and the same effect as that of this example can be obtained.

### Example 8

In this embodiment, as shown in FIG. 17, an image forming apparatus using a spacer that a concavo-convex depth becomes deeper in a rear plate side in comparison with a face plate side was produced.

As for the spacer used for this example, concavities and convexities were formed in its surface by cutting alumina. Size of the obtained spacer base material was 1.8 mm×100 mm×0.2 mm thick, and rectangular concavities and convexities were formed in the surface in a cycle of 50 μm by cutting. Concavo-convex depths were 12 μm in an area which was ⅓ from one end portion, and 5 μm in the remaining area.

The same high-resistivity film as that in the first example was formed on the worked spacer. At this time, the high resistivity film was formed with rotating the base material with an axis of the spacer base material in a longitudinal direction as a center so that a resistivity distribution might not arise in a rectangular concavo-convex portion. A sheet resistance value of the obtained high resistivity film was 1×10¹² Ω/square.

Subsequently, it was arranged and fixed to the rear plate having been produced separately so that it might abut on the rear plate in a side where a concavo-convex depth of the spacer base material was deep.

Furthermore, with the face plate 102 and the side wall 106 which had been produced separately, an envelope was formed, and evacuation and formation of an electron source were performed. By performing sealing after this, the spacer was completely fixed in a predetermined position in a panel by atmospheric pressure applied from outside the envelope, and an image forming apparatus was obtained.

When the same evaluation as that in the fourth example was performed using the produced image forming apparatus, displacement of a position of a nearest light-emitting spot by a driving pulse width was 4 μm.

On the other hand, a spacer which was formed as a depth being made at 5 μm in all the concavities and convexities was produced as a comparative example by the same method, and similarly to the example, a position of a light-emitting spot by electrons emitted from an electron-emitting device nearest to the spacer for every driving pulse width was observed in detail. In consequence, since an aspect that the position of the light-emitting spot was displaced by about 20 μm as the driving pulse width becomes wide was observed, validity and predominancy of the present invention of suppressing an influence of charge under drive could be confirmed. In addition, in this example, construction which a depth of a groove becomes deep gradually toward a rear plate from a face plate may be adopted, and also in this case, the same effect as that of this example can be obtained.

### Example 9

A spacer used in this example is illustrated in FIG. 18.

In this embodiment, a concavo-convex shape was formed so that an area of a top surface of a convex portion might change gradually in a direction of a width of the spacer by cutting an alumina base material. Size of the produced spacer base material was 1.8 mm×100 mm×0.2 mm thick, and a concavo-convex depth was 8 μm, and a concavo-convex cycle was 50 μm. A sectional shape of concavities and convexities was a rough trapezoid, a maximum angle of inclination was 60°, a width of a top surface of a convex portion was made into 20 to 5 μm, and a length of a groove (concave portion) in a direction to a face plate from a rear plate was set constant at 20 μm.

After the same high-resistivity film as that in the fourth example was formed on the worked spacer, and thereafter, it was fixed on the rear plate. At this time, it was arranged so that a side (long side) where a width of a top surface (length of a convex portion in a direction to the face plate from the rear plate) might become a rear plate side.

Furthermore, with the face plate 102 and the side wall 1016 which had been produced separately, an envelope was formed, and evacuation and formation of an electron source were performed. By performing sealing after this, the spacer was completely fixed in a predetermined position in a panel by atmospheric pressure applied from outside the envelope, and an image forming apparatus was produced.

When the same evaluation as that in the fourth example was performed using the produced image forming apparatus, displacement of a position of a nearest light-emitting spot by a driving pulse width was 4 μm.

On the other hand, as a comparative example a spacer formed by a length of a top face ((length of a convex portion in a direction to the face plate from the rear plate) in a direction to a face plate from a rear plate being set constant at 20 μm was produced by the same method. Using this, similarly to the example, a position of a light-emitting spot by emitted electrons from an electron-emitting device nearest to the spacer for every driving pulse width was observed in detail. In consequence, since an aspect that the position of the light-emitting spot was displaced by about 18 μm as the driving pulse width becomes wide was observed, validity and predominancy of the present invention of suppressing an influence of charge under drive could be confirmed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2006-151451, filed May 31, 2006, 2006-151452, filed May 31, 2006, and 2007-125150, filed May 10, 2007, which are hereby incorporated by reference herein in their entirety.

1. An image display device which has:
a first substrate that has an electron source which includes a plurality of electron-emitting devices;
a second substrate which has an acceleration electrode for accelerating electrons, emitted from the electron source, and is arranged opposite to the first substrate; and
a spacer which is arranged between the first substrate and the second substrate, and specifies a gap of the first substrate and the second substrate, characterized in that the spacer has concavo-convex structure in its main surface, and fulfills the following relational expressions with a length of a concave portion of the concavo-convex structure in a direction to the second substrate from the first substrate be A, a length of a convex portion be B, a secondary electron emission coefficient of the concave portion be δ_{A}, a secondary electron emission coefficient of the convex portion be δ_{B}, a probability of an electron being incident into the concave portion and being trapped by the concave portion be α, a depth of the concave-convex structure be d, and electric field strength between the first substrate and the second substrate during operation of the image display device be E.
$$\begin{matrix}{δ}_{A} ≦ \frac{1}{1 - α} & ( Formula 1 ) \\ \sqrt[α \geq ]{\frac{5 A}{E}} . & ( Formula 2 ) \\ 0.5 \times ( \frac{{δ}_{B} - 1}{( α - 1 ) {δ}_{A} + 1} ) ≦ \frac{A}{B} ≦ 1.5 \times ( \frac{{δ}_{B} - 1}{( α - 1 ) {δ}_{A} + 1} ) . & ( Formula 3 )\end{matrix}$$

2. The image display device according to claim 1, characterized in that the concavo-convex ratio A/B with the concavo-convex structure formed in the spacer surface fulfills:
$$0.8 \times ( \frac{{δ}_{B} - 1}{( α - 1 ) {δ}_{A} + 1} ) ≦ \frac{A}{B} ≦ 1.2 \times ( \frac{{δ}_{B} - 1}{( α - 1 ) {δ}_{A} + 1} ) \qquad ( Formula 4 )$$

3. The image display device according to claim 1, characterized in that the d fulfills the following formula:
$$\sqrt[α \geq ]{\frac{20 A}{E}} \qquad ( Formula 5 )$$

4. An image display device which has:
a first substrate that has an electron source which includes a plurality of electron-emitting devices;
a second substrate which has an acceleration electrode for accelerating electrons, emitted from the electron source, and is arranged opposite to the first substrate; and
a spacer which is arranged between the first substrate and the second substrate, and specifies a gap of the first substrate and the second substrate, characterized in that the spacer has concavo-convex structure in its main surface, a length of a concave portion of the concavo-convex structure in a direction to the second substrate from the first substrate be A, a length of a convex portion be B, a concavo-convex ratio A/B becomes large gradually from a side of the first substrate toward a side of the second substrate.

5. The image display device according to claim 4, characterized in that the concavo-convex ratio A/B becomes large gradually from a side of the first substrate toward a side of the second substrate, becomes a maximum value, and thereafter, becomes small again.

6. The image display device according to claim 5, characterized in that a depth of the concavo-convex structure is 3 μm or more and 20 μm or less, a length A of a concave portion and a length B of the convex portion is r/10 or less, and the concavo-convex ratio A/B is 1 or more and 30 or less, where r is a distance between the main surface of the spacer and the electron-emitting device nearest to the main surface.

7. The image display device according to claim 1, characterized in that, a distance between a main surface of the spacer, and the electron source, which is in a nearest location from the spacer, be r, a length A+B of the concavo-convex structure is r or less.

8. An image display device which has:
a first substrate that has an electron source which includes a plurality of electron-emitting devices;
a second substrate which has an acceleration electrode for accelerating electrons, emitted from the electron source, and is arranged opposite to the first substrate; and
a spacer which is arranged between the first substrate and the second substrate, and specifies a gap of the first substrate and the second substrate, characterized in that the spacer has concavo-convex structure in its main surface, the concavo-convex structure includes a plurality of concavo-convex shapes where maximum angle of inclinations of inclined planes are different, and the maximum angle of inclination of the concavo-convex shape formed in an area in a side of the first substrate is larger than the maximum angle of inclination of the concavo-convex shape formed in an area in a side of the second substrate.

9. The image display device according to claim 8, characterized in that the maximum angle of inclination of the concavo-convex shape becomes small gradually from a side of the first substrate toward a side of the second substrate.

10. The image display device according to claim 8, characterized in that, in the concavo-convex structure of the spacer, a plurality of concavo-convex shape is formed periodically, and a cycle of the concavo-convex shape in a side of the second substrate is longer than one in a side of the first substrate.

11. The image display device according to claim 8, characterized in that the maximum angle of inclination of the concavo-convex shape is 20° or more and 90° or less.

12. An image display device which has:
a first substrate that has an electron source which includes a plurality of electron-emitting devices;
a second substrate which has an acceleration electrode for accelerating electrons, emitted from the electron source, and is arranged opposite to the first substrate; and
a spacer which is arranged between the first substrate and the second substrate, and specifies a gap of the first substrate and the second substrate, characterized in that the spacer has an concavo-convex structure, where a plurality of concavo-convex shapes are formed periodically, in its main surface, and a cycle of the concavo-convex shape in a side of the second substrate is longer than one in a side of the first substrate.

13. The image display device according to claim 12, characterized in that the cycle of the concavo-convex shape becomes large gradually from a side of the first substrate toward a side of the second substrate.

14. The image display device according to claim 12, wherein a cycle of the concavo-convex shape is one-third or less of a distance to the electron-emitting device, which is in a location nearest to the spacer, from the main surface of the spacer.

15. The image display device according to claim 12, wherein a cycle of the concavo-convex shape is one-tenth or less of a distance to the electron-emitting device, which is in a location nearest to the spacer, from the main surface of the spacer.

16. An image display device which has:
a first substrate that has an electron source which includes a plurality of electron-emitting devices;
a second substrate which has an acceleration electrode for accelerating electrons, emitted from the electron source, and is arranged opposite to the first substrate; and
a spacer which is arranged between the first substrate and the second substrate, and specifies a gap of the first substrate and the second substrate, characterized in that the spacer has concavo-convex structure in its main surface, the concavo-convex structure includes a plurality of concavo-convex shapes whose depths are different, and the depth of the concave-convex shape formed in an area in a side of the first substrate is deeper than the depth of the concave-convex shape formed in an area in a side of the second substrate.

17. The image display device according to claim 16, characterized in that the depth of the concavo-convex shape becomes shallow gradually from a side of the first substrate toward a side of the second substrate.

18. The image display device according to claim 16, wherein the depth of the concavo-convex shape is 4 μm or more.

19. The image display device according to claim 16, wherein the depth of the concavo-convex shape is 20 μm or less.
